(19) United States
(12) Patent Application Publication
(10) Pub. No.: US 2026/0213876 A1
(43) Pub. Date: Jul. 23, 2026

(54) HYBRID RECEIVER WITH LEARNABLE DECIDER

(71) Applicant: HUAWEI TECHNOLOGIES CO., LTD., Shenzhen (CN)

(72) Inventors: Mohanad Ali Abdulwahid OBEED, Ottawa (CA); Ming JIAN, Kanata (CA)

(21) Appl. No.: 19/035,082

(22) Filed: Jan. 23, 2025

(51) Int. Cl. H04L 1/00; H04B 17/309; H04L 5/00; H04L 25/02; H04L 27/01

(52) U.S. Cl. CPC H04L 1/005; H04B 17/309; H04L 5/0007; H04L 5/0048; H04L 25/0228; H04L 27/01

(57) ABSTRACT

A method for processing a signal, comprising acquiring the signal by a receiver of a communication system; extracting a pilot signal based on the acquired signal, the pilot signal being indicative of at least one channel condition parameter of a communication channel over which the signal has been acquired; generating, using a first Neural Network (NN), a selection parameter based on the pilot signal; selectively employing, based on the selection parameter, a second NN for generating a processed signal, the second NN having been trained to generate the processed signal based on the acquired signal, the processed signal being indicative of data symbols representing the acquired signal; and decoding the processed signal using a decoder of the communication system.

### FIELD

The present technology is generally related to communication systems, and more specifically, to hybrid receiver with a learnable decider.

### BACKGROUND

Broadly speaking, a communication system comprises a transmitter, a receiver, and a channel. The transmitter and the receiver are designed to track a channel change and mitigate the impact of channel uncertainties.

One way to track channel change is to send pilot signals so the receiver can use these pilots to equalize and detect the received symbols. A common approach of the channel estimation is the Least Square (LS) technique, while the common approach for equalization is the Linear Minimum Mean Square Error (LMMSE) technique. However, due to the rapid change of wireless channels, pilot signals may not be well-suited to track such change.

Therefore, Deep Learning (DL) approaches can be used to detect orthogonal frequency-division multiplexing (OFDM) received symbols and may be preferable compared to traditional detection approaches (i.e., estimating the channels using the LS technique and use the LMMSE technique to detect the symbols). However, if the actual channel distribution is different and/or shifted from the one that has been used in training the DL models, the neural receivers may provide a lower performance than the traditional receivers. In other words, the neural receivers may not be able to generalize well to the unseen channel distributions, and there are an infinite number of different channel environments.

Deep learning-based approaches can be used to replace a specific function in wireless receivers, such as the channel estimation function, or to replace multiple functions like channel estimation, equalization, and demapping functions.

In an article entitled “Learning the MMSE channel estimator”, authored by Neumann et al. published at IEEE Transactions on Signal Processing in 2018, and the content of which is incorporated herein by reference in its entirety, there is provided a neural network for performing channel estimation.

In an article entitled “Complex CNN-based equalization for communication signal”, authored by Chang et al., published at IEEE 4th International Conference on Signal and Image Processing in 2019, and the content of which is incorporated herein by reference in its entirety, there is provided a convolutional neural network for performing equalization.

In an article entitled ““Machine LLRning”: Learning to Softly Demodulate”, authored by Shental et al., published at IEEE Globecom Workshops in 2019, and the content of which is incorporated herein by reference in its entirety, there is provided a convolutional neural network for performing demapping and thereby calculating the log-likelihood ratios (LLRs).

In an article entitled “Deep learning-based channel estimation for beamspace mmWave massive MIMO systems”, authored by He et al., published at IEEE Wireless Communications Letters in 2018, and the content of which is incorporated herein by reference in its entirety, there is provided a multi-layer perceptron neural network to jointly estimate the channels and detect the signals.

In an article entitled “Deep-waveform: A learned OFDM receiver based on deep complex-valued convolutional networks”, authored by Zhao et al., published at IEEE Journal on Selected Areas in Communications in 2021, and the content of which is incorporated herein by reference in its entirety, there is provided a neural network to directly detect the signals from the received time-domain signals.

In an article entitled “An introduction to deep learning for the physical layer”, authored by O'shea et al., published at IEEE Transactions on Cognitive Communications and Networking in 2017, and the content of which is incorporated herein by reference in its entirety, there is provided an end-to-end deep learning based communication system, where the transmitter and the receiver are both trained jointly to form and detect the signals.

In an article entitled “DeepRx: Fully convolutional deep learning receiver”, authored by Honkala et al., published at IEEE Transactions on Wireless Communications in 2021, and the content of which is incorporated herein by reference in its entirety, there is provided a CNN with residual connections to handle the received frequency-domain OFDM signals and provide the soft bits as outputs, and there is also provided a receiver that utilizes the frequency and temporal correlations in addition to the pilot signals in every received resource grid to improve the produced soft bits, which leads to minimizing the bit error rate (BER).

Even when the DL model is trained on a variety of channel models, there can be channels with specific characteristics that cause the neural receiver to underperform the traditional neural receiver. This implies that deploying DL models in dynamic channel environments might yield better performance in certain scenarios, while potentially delivering worse results in others, compared to traditional methods.

### SUMMARY

Developers have devised methods and devices for overcoming at least some drawbacks present in prior art solutions.

Developers have realized that conventional solutions do not consider the dynamic nature of the wireless channels that may result deep learning models underperforming due to the distribution shifts happened in the communication channels. In some scenarios, neural networks may underperform when the input distribution at the inference time deviates from the input distribution used to train the models.

To address the dynamic nature of wireless communications, developers have devised using adaptive deep learning models, such as meta-learning approaches, which can be fine-tuned online as the channel distribution shifts. For example, an adaptive neural network can be configured in the receiver to track the channel distribution change. In adaptive neural networks, the weights of the model must be tuned for every distribution shift to avoid providing disastrous results.

However, these methods face several challenges, including the computational demands of online training, the necessity for true labels during each shift, and the difficulty in detecting distribution shifts early. In some embodiments, there is provided a receiver based on selectively employing both the deep learning and the traditional processing according to the received signals distribution.

In one aspect of the present technology, there is provided a hybrid, wireless, comprising one or more components of a traditional receiver (e.g., using LMMSE technique) and of a neural receiver (e.g., trained deep learning model). The hybrid receiver may aid in mitigating performance issues of neural receivers during channel distribution shift(s), and/or aid in obtaining a comparatively higher performance of the neural receivers during limited channel distribution shift(s).

In some embodiments of the hybrid receiver, there is provided a discriminator NN that allows for integration of traditional functions and a deep learning model into a hybrid receiver configuration. It can be said that the discriminator NN, in a sense, acts as a decision-maker for selectively determining which detector is to be employed for a respective resource block. The discriminator NN makes the selection of a type of processing pipeline to be used by the hybrid receiver for respective resource grid(s). It is contemplated that the discriminator NN may aid in identifying whether a distribution shift occurred or not.

In some embodiments of the present technology, the training process for the neural networks differs from deterministic approaches. First, the neural receiver is trained on a given dataset. Subsequently, a dataset is generated based on the performance of both the deterministic receiver and the neural receiver. This dataset is then used to train the discriminator neural network. By employing this training process, the discriminator neural network is enabled to understand the capability limits of each receiver and select an appropriate receiver for a given signal condition.

Some embodiments of the present technology provide hybrid receiver architectures that may involve different configurations for processing signals. For example, in some embodiments, only one processing option (either the deterministic receiver or the neural receiver) is utilized for signal processing. In other embodiments, the deterministic receiver may be employed for signal processing, while the neural receiver can be optionally utilized as a complementary component for improving performance. In further embodiments, the neural receiver may be employed for signal processing, with the deterministic receiver optionally used as a complementary component for improving performance.

The flexibility of these architectures may allow trade-offs between computational complexity and robustness in processing. For instance, in embodiments where only one processing option is utilized, computational complexity may be lower. However, the discriminator may exhibit limited accuracy due to restricted input information. In embodiments where both processing options are employed, computational demands may increase, but the discriminator can benefit from enhanced input information, which may lead to improved accuracy in receiver selection.

In the context of the present technology, the hybrid receiver can be applied to a wide range of wireless communication systems. For instance, it may be used in systems with single or multiple antennas, operating in microwave or millimeter-wave frequency bands, and applicable to mobile or fixed stations. Furthermore, the hybrid receiver may support any modulation order or coding scheme.

To evaluate receiver functionality, outputs may be assessed based on the given inputs. In some embodiments, the hybrid receiver consists of two receivers or processing paths: one based on deterministic techniques with predictable outputs and the other employing a neural network architecture. The deterministic processing path consists of well-defined functions that can be accurately simulated. For a given input, if the output matches the deterministic processing path for certain input distributions but diverges for others, it may indicate that the receiver employs a hybrid configuration that integrates both deterministic and neural network-based paths.

Embodiments of the present technology may be applicable to scenarios where deep learning models replace traditional algorithms, particularly in cases where deep learning does not consistently outperform deterministic approaches. For example, some embodiments of the hybrid system may address problems such as digital predistortion (DPD), peak-to-average power ratio (PAPR) reduction, or specific time-domain processing functions in receivers. Additionally, the hybrid system may be employed for individual functions within receivers, including channel estimation, equalization, demapping, or decoding.

In a first broad aspect of the present technology, there is provided a method for processing a signal, comprising: acquiring the signal by a receiver of a communication system; extracting a pilot signal based on the acquired signal, the pilot signal being indicative of at least one channel condition parameter of a communication channel over which the signal has been acquired; generating, using a first Neural Network (NN), a selection parameter based on the pilot signal; selectively employing, based on the selection parameter, a second NN for generating a processed signal, the second NN having been trained to generate the processed signal based on the acquired signal, the processed signal being indicative of data symbols representing the acquired signal; and decoding the processed signal using a decoder of the communication system.

In some embodiments of the method, the method further comprises selectively employing, based on the selection parameter, an NN-based equalizer and an NN-based demapper for generating the processed signal, wherein the selectively employing the NN-based equalizer and the NN-based demapper comprises: generating an equalized signal from the acquired signal using the NN-based equalizer; and generating a demapped signal from the equalized signal using the NN-based demapper.

In some embodiments of the method, the selectively employing comprises comparing the selection parameter against a predetermined threshold.

In some embodiments of the method, the acquired signal is a time-domain signal, the extracting the pilot signal based on the time-domain signal comprises: generating a frequency-domain representation of the time-domain signal; and extracting the pilot signal from the frequency-domain representation.

In some embodiments of the method, the first NN is trained using a data set including: pilot training signals, corresponding labels associated with the pilot training signals, a first processed training signal, generated by the second NN, based on the pilot training signals, and a second processed training signal, generated by a Linear Minimum Mean Square Error (LMMSE)-based equalizer and a deterministic demapper, based on the pilot training signals; wherein the first NN is configured to output a parameter indicative of whether the first processed training signal has a better performance than the second processed training signal, according to a performance metric.

In some embodiments of the method, the performance metric is a bit error rate parameter.

In some embodiments of the method, the acquired signal is an orthogonal frequency division multiplexing (OFDM) signal.

In some embodiments of the method, the at least one channel condition parameter includes a signal-to-noise ratio (SNR), a channel gain, a phase shift, a noise variance, a delay spread, and a Doppler shift.

In a second broad aspect of the present technology, there is provided a method for processing a signal, comprising: acquiring the signal by a receiver of a communication system; extracting a pilot signal based on the acquired signal, the pilot signal being indicative of at least one channel condition parameter of a communication channel over which the signal has been acquired; generating an equalized signal based on the acquired signal and the at least one channel condition parameter, the equalized signal being indicative of a modified acquired signal generated based on the at least one channel condition parameter; generating a first demapped signal based on the equalized signal; generating, using a first Neural Network (NN), a selection parameter based on the first demapped signal and the pilot signal; selectively employing, based on the selection parameter, a second NN for generating a second demapped signal based on the first demapped signal and the acquired signal; and decoding the second demapped signal using a decoder of the communication system.

In some embodiments of the method, the first demapped signal is indicative of a first set of log-likelihood ratios (LLRs), the first set of LLRs representing a first likelihood of data symbols representing the acquired signal; and the second demapped signal is indicative of a second set of log-likelihood ratios (LLRs), the second set of LLRs representing a second likelihood of data symbols representing the acquired signal.

In some embodiments of the method, the selectively employing comprises comparing the selection parameter against a predetermined threshold.

In some embodiments of the method, the acquired signal is a time-domain signal, the generating the equalized signal based on the time-domain signal comprises: generating a frequency-domain representation of the time-domain signal; and generating the equalized signal based on the frequency-domain representation.

In some embodiments of the method, the generating the equalized signal comprises generating the equalized signal based on the frequency domain representation and the at least one channel condition parameter.

In some embodiments of the method, the first NN is trained using a data set including: pilot training signals, corresponding labels associated with the pilot training signals, a first demapped training signal, generated by a Linear Minimum Mean Square Error (LMMSE)-based equalizer and a deterministic demapper, based on the pilot training signals; and a second demapped training signal, generated by the second NN, based on the pilot training signals; wherein the first NN is configured to output a parameter indicative of whether the second demapped training signal has a better performance than the first demapped training signal, according to a performance metric.

In some embodiments of the method, the performance metric is a bit error rate parameter.

In a third broad aspect of the present technology, there is provided a method for processing a signal, comprising: acquiring the signal by a receiver of a communication system; extracting a pilot signal based on the acquired signal, the pilot signal being indicative of at least one channel condition parameter of a communication channel over which the signal has been acquired; generating, using a first Neural Network (NN), an equalized signal based on the acquired signal; generating, using the first NN, a first demapped signal based on the equalized signal; generating, using a second Neural Network (NN), a selection parameter based on the first demapped signal and the pilot signal; selectively employing, based on the selection parameter, a Linear Minimum Mean Square Error (LMMSE)-based equalizer for generating a second equalized signal; and a deterministic demapper for generating a second demapped signal based on the second equalized signal; and decoding the second demapped signal using a decoder of the communication system.

In some embodiments of the method, the equalized signal is indicative of a modified acquired signal generated based on the at least one channel condition parameter.

In some embodiments of the method, the first demapped signal is indicative of a first set of log-likelihood ratios (LLRs), the first set of LLRs representing a first likelihood of data symbols representing the acquired signal; and the second demapped signal is indicative of a second set of log-likelihood ratios (LLRs), the second set of LLRs representing a second likelihood of data symbols representing the acquired signal.

In some embodiments of the method, the second NN is trained using a data set including: pilot training signals, corresponding labels associated with the pilot training signals, a first demapped training signal, generated by the first NN, based on the pilot training signals; and a second demapped training signal, generated by a Linear Minimum Mean Square Error (LMMSE)-based equalizer and a deterministic demapper, based on the pilot training signals; wherein the second NN is configured to output a parameter indicative of whether the first demapped training signal has a better performance than the second demapped training signal, according to a performance metric.

In some embodiments of the method, the selectively employing comprises comparing the selection parameter against a predetermined threshold.

In some embodiments of the method, the performance metric is a bit error rate parameter.

In a fourth broad aspect of the present technology, there is provided an electronic device comprising a non-transitory computer-readable medium and a processor, the non-transitory computer-readable medium comprising instructions, which upon being executed by the processor, configure the processor to: acquire the signal by a receiver of a communication system; extract a pilot signal based on the acquired signal, the pilot signal being indicative of at least one channel condition parameter of a communication channel over which the signal has been acquired; generate, using a first Neural Network (NN), a selection parameter based on the pilot signal; selectively employ, based on the selection parameter, a second NN for generating a processed signal, the second NN having been trained to generate the processed signal based on the acquired signal, the processed signal being indicative of data symbols representing the acquired signal; and decode the processed signal using a decoder of the communication system.

In some embodiments of the electronic device, the processor is further configured to selectively employ, based on the selection parameter, an NN-based equalizer and an NN-based demapper for generating the processed signal, wherein the selectively employing the NN-based equalizer and the NN-based demapper comprises: generating an equalized signal from the acquired signal using the NN-based equalizer; and generating a demapped signal from the equalized signal using the NN-based demapper.

In some embodiments of the electronic device, the selectively employing comprises comparing the selection parameter against a predetermined threshold.

In some embodiments of the electronic device, the acquired signal is a time-domain signal, the extracting the pilot signal based on the time-domain signal comprises: generating a frequency-domain representation of the time-domain signal; and extracting the pilot signal from the frequency-domain representation.

In some embodiments of the electronic device, the first NN is trained using a data set including: pilot training signals, corresponding labels associated with the pilot training signals, a first processed training signal, generated by the second NN, based on the pilot training signals, and a second processed training signal, generated by a Linear Minimum Mean Square Error (LMMSE)-based equalizer and a deterministic demapper, based on the pilot training signals; wherein the first NN is configured to output a parameter indicative of whether the first processed training signal has a better performance than the second processed training signal, according to a performance metric.

In some embodiments of the electronic device, the performance metric is a bit error rate parameter.

In some embodiments of the electronic device, the acquired signal is an orthogonal frequency division multiplexing (OFDM) signal.

In some embodiments of the electronic device, the at least one channel condition parameter includes a signal-to-noise ratio (SNR), a channel gain, a phase shift, a noise variance, a delay spread, and a Doppler shift.

In a fifth broad aspect of the present technology, there is provided an electronic device comprising a non-transitory computer-readable medium and a processor, the non-transitory computer-readable medium comprising instructions, which upon being executed by the processor, configure the processor to acquire the signal by a receiver of a communication system; extract a pilot signal based on the acquired signal, the pilot signal being indicative of at least one channel condition parameter of a communication channel over which the signal has been acquired; generate an equalized signal based on the acquired signal and the at least one channel condition parameter, the equalized signal being indicative of a modified acquired signal generated based on the at least one channel condition parameter; generate a first demapped signal based on the equalized signal; generate, using a first Neural Network (NN), a selection parameter based on the first demapped signal and the pilot signal; selectively employ, based on the selection parameter, a second NN for generating a second demapped signal based on the first demapped signal and the acquired signal; and decode the second demapped signal using a decoder of the communication system.

In some embodiments of the electronic device, the first demapped signal is indicative of a first set of log-likelihood ratios (LLRs), the first set of LLRs representing a first likelihood of data symbols representing the acquired signal; and the second demapped signal is indicative of a second set of log-likelihood ratios (LLRs), the second set of LLRs representing a second likelihood of data symbols representing the acquired signal.

In some embodiments of the electronic device, the selectively employing comprises comparing the selection parameter against a predetermined threshold.

In some embodiments of the electronic device, the acquired signal is a time-domain signal, the generating the equalized signal based on the time-domain signal comprises: generating a frequency-domain representation of the time-domain signal; and generating the equalized signal based on the frequency-domain representation.

In some embodiments of the electronic device, the generating the equalized signal comprises generating the equalized signal based on the frequency domain representation and the at least one channel condition parameter.

In some embodiments of the electronic device, the first NN is trained using a data set including: pilot training signals, corresponding labels associated with the pilot training signals, a first demapped training signal, generated by a Linear Minimum Mean Square Error (LMMSE)-based equalizer and a deterministic demapper, based on the pilot training signals; and a second demapped training signal, generated by the second NN, based on the pilot training signals; wherein the first NN is configured to output a parameter indicative of whether the second demapped training signal has a better performance than the first demapped training signal, according to a performance metric.

In some embodiments of the electronic device, the performance metric is a bit error rate parameter.

In a sixth broad aspect of the present technology, there is provided an electronic device comprising a non-transitory computer-readable medium and a processor, the non-transitory computer-readable medium comprising instructions, which upon being executed by the processor, configure the processor to acquire the signal by a receiver of a communication system; extract a pilot signal based on the acquired signal, the pilot signal being indicative of at least one channel condition parameter of a communication channel over which the signal has been acquired; generate, using a first Neural Network (NN), an equalized signal based on the acquired signal; generate, using the first NN, a first demapped signal based on the equalized signal; generate, using a second Neural Network (NN), a selection parameter based on the first demapped signal and the pilot signal; selectively employ, based on the selection parameter, a Linear Minimum Mean Square Error (LMMSE)-based equalizer for generating a second equalized signal; and a deterministic demapper for generating a second demapped signal based on the second equalized signal; and decode the second demapped signal using a decoder of the communication system.

In some embodiments of the electronic device, the equalized signal is indicative of a modified acquired signal generated based on the at least one channel condition parameter.

In some embodiments of the electronic device, the first demapped signal is indicative of a first set of log-likelihood ratios (LLRs), the first set of LLRs representing a first likelihood of data symbols representing the acquired signal; and the second demapped signal is indicative of a second set of log-likelihood ratios (LLRs), the second set of LLRs representing a second likelihood of data symbols representing the acquired signal.

In some embodiments of the electronic device, the second NN is trained using a data set including: pilot training signals, corresponding labels associated with the pilot training signals, a first demapped training signal, generated by the first NN, based on the pilot training signals; and a second demapped training signal, generated by a Linear Minimum Mean Square Error (LMMSE)-based equalizer and a deterministic demapper, based on the pilot training signals; wherein the second NN is configured to output a parameter indicative of whether the first demapped training signal has a better performance than the second demapped training signal, according to a performance metric.

In some embodiments of the electronic device, the selectively employing comprises comparing the selection parameter against a predetermined threshold.

In some embodiments of the electronic device, the performance metric is a bit error rate parameter.

In the context of the present technology, “deterministic receiver” refers to a signal processing system that uses predefined mathematical algorithms, such as linear minimum mean square error (LMMSE) equalization and conventional demapping, to process received signals.

In the context of the present technology, “hybrid receiver” refers to a receiver architecture that integrates components of deterministic receivers and neural network-based models, enabling selective use of either approach based on the characteristics of the received signal.

In the context of the present technology, “pilot signal” refers to a reference signal embedded in the transmitted data, used for estimating channel conditions and facilitating subsequent signal processing tasks.

In the context of the present technology, “channel condition parameter” refers to a characteristic of the communication channel, such as signal-to-noise ratio (SNR), noise variance, or Doppler shift, that affects signal transmission and processing.

In the context of the present technology, “discriminator NN” refers to a neural network trained to analyze input features, such as pilot signals, and predict which processing approach, deterministic or neural network-based, is optimal for a given signal.

In the context of the present technology, “log-likelihood ratio (LLR)” refers to a probabilistic measure representing the likelihood of a bit in a symbol being 0 or 1, commonly used in demapping and error correction processes.

In the context of the present technology, “resource block” refers to a specific allocation of frequency and time resources in a communication system, used for transmitting data.

In the context of the present technology, “channel equalization” refers to the method of mitigating distortions in the received signal caused by the communication channel, using mathematical models or neural networks.

In the context of the present technology, “demapping” refers to the method of converting received symbols into corresponding data bits based on the modulation scheme.

In the context of the present technology, “distribution shift” refers to a change in the statistical properties of the communication channel or input signals, which can affect the performance of machine learning models trained on prior distributions.

In the context of the present technology, “channel estimation” refers to the method of analyzing pilot signals to determine channel condition parameters, such as signal-to-noise ratio (SNR) or phase shift, that characterize the communication channel.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different implementations of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in implementations of this application are used to distinguish between a plurality of objects, and are not used to limit a sequence, a time sequence, priorities, or importance of the plurality of objects.

A person skilled in the art should understand that implementations of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or on another programmable device provide steps for implementing specific functions as described in one or more procedures in the flowcharts and/or one or more blocks in the block diagrams.

It is clear that a person skilled in the art can make various modifications and variations to this application without departing from the scope of this disclosure. This disclosure is intended to cover these modifications and variations of this application provided that they fall within the scope of protection defined by the following claims and their equivalent technologies.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates a schematic illustration of an example communication system, in accordance with at least some non-limiting implementations of the present technology.

FIG. 2 illustrates a schematic illustration of another example communication system, in accordance with at least some non-limiting implementations of the present technology.

FIG. 3 illustrates a schematic illustration of an apparatus wirelessly communicating with another apparatus within a communication system, in accordance with at least some non-limiting implementations of the present technology.

FIG. 4 illustrates a schematic illustration of an example apparatus, in accordance with at least some non-limiting implementations of the present technology.

FIG. 5 illustrates a schematic illustration of another example apparatus, in accordance with at least some non-limiting implementations of the present technology.

FIG. 6A illustrates an overview of a traditional receiver architecture, known in the art.

FIG. 6B illustrates an overview of a receiver employing a neural network architecture, known in the art.

FIG. 7 illustrates an overview of a communication system comprising a transmitter, a communication channel, and a receiver, in accordance with at least some non-limiting implementations of the present technology.

FIG. 8 illustrates a hybrid receiver architecture including a switching mechanism to selectively route a signal to either a deterministic receiver or a neural receiver, in accordance with at least some non-limiting embodiments of the present technology.

FIG. 9 illustrates a hybrid receiver architecture including a switching mechanism to selectively route a signal to a neural enhancer, in accordance with at least some non-limiting embodiments of the present technology.

FIG. 10 illustrates a hybrid receiver architecture including a switching mechanism to selectively route a signal to a deterministic receiver, in accordance with at least some non-limiting embodiments of the present technology.

FIG. 11 is a scheme-block illustration of a method executed by a processor of an apparatus of FIG. 3, in accordance with at least some non-limiting embodiments of the present technology.

FIG. 12 is a scheme-block illustration of another method executed by a processor of an apparatus of FIG. 3, in accordance with at least some non-limiting embodiments of the present technology.

FIG. 13 is a scheme-block illustration of yet another method executed by a processor of an apparatus of FIG. 3, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some implementations of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

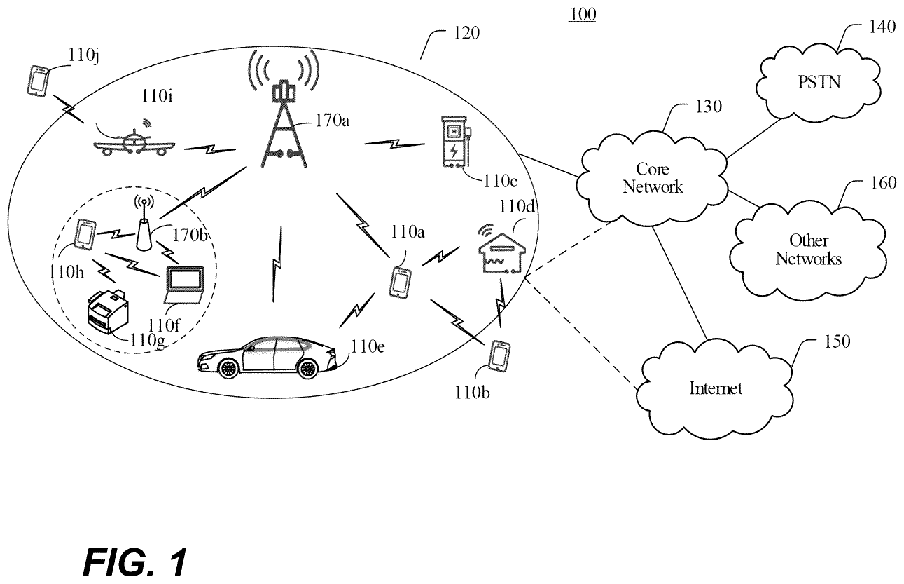

FIG. 1 illustrates a schematic illustration of an example communication system, in accordance with at least some non-limiting implementations of the present technology.

There is shown a communication system 100 that includes a radio access network (RAN) 120, one or more communication electronic devices (EDs) 10a, 110b, 110c, 110d, 110e, 110f, 110g, 110h, 110i, 110j (collectively referred to as 110), a core network 130, a Public Switched Telephone Network (PSTN) 140, the Internet 150, and other networks 160. The RAN 120 may include, but is not limited to, a future generation RAN, or a legacy RAN such as, but not limited to, 5th generation (5G), 4th generation (4G), 3rd generation (3G) or 2nd generation (2G) radio access network.

The RAN 120 may be, for example, an Evolved Universal Mobile Telecommunications System (UMTS) Terrestrial Radio Access Network (E-UTRAN), a NextGen RAN (NG RAN), or some other type of RAN. Examples of RAN 120 based on the evolution of telecommunications standards include, but is not limited to, GSM (Global System for Mobile Communications) and CDMA (Code Division Multiple Access) for 2G, UMTS (Universal Mobile Telecommunications System) based on WCDMA (Wideband Code Division Multiple Access) and CDMA2000 for 3G, LTE (Long-Term Evolution) and WiMAX (Worldwide Interoperability for Microwave Access) for 4G, and NR (New Radio) for 5G.

In some implementations, The RAN 120 may use any radio access technology (RAT) in the wireless interface between the one or more EDs 110 and the RAN 120. In some implementations, the term “radio access” may refer to the future generation air interface standards which may include both terrestrial networks (TNs) and non-terrestrial networks (NTNs). These networks will be described in greater detail below in conjunction with various implementations. The one or more communication EDs 110 (also referred to as “user equipment”) are configured to connect (e.g., communicatively couple) with each other or to one or more network nodes 170a, 170b (collectively referred to as 170) in the RAN 120.

The core network (CN) 130 is a part of the communication system 100 and consists of network nodes (e.g., 170a, 170b) which provide support for the network features and telecommunication services. In some implementations, the CN 130 may be dependent on the RAT used in the communication system 100. In other implementations, the CN 130 may be access-agnostic, i.e., the CN 130 may be independent of the RAT used in the communication system 100.

There are different types of CN 130, for different 3GPP system generations. For example, the CN 130 is the Evolved Packet Core (EPC) in 4G, also known as the Evolved Packet System (EPS). In another example, the CN 130 is the 5G Core (5GC) which was developed as part of the 5G System (5GS). The CN 130 also enables integration of different 3GPP and non-3GPP access types.

In some implementations and referring to FIG. 1, the CN 130 also provides the interface towards external networks that may include the PSTN 140, the Internet 150, and other networks 160 in the communication system 100.

In general, the communication system 100 facilitates interaction between multiple wireless or wired elements. The communication system 100 may transmit different types of content, such as voice, data, video, and/or text, through different transmission methods such as, but not limited to, broadcast, multicast, groupcast, and unicast. Additionally, the communication system 100 operates by allocating and/or sharing resources, such as carrier spectrum bandwidth, among its constituent elements.

The communication system 100 may provide a wide range of communication services and applications including, but not limited to, Enhanced Mobile Broadband (eMBB) services, Ultra-Reliable Low-Latency Communication (URLLC) services, Massive Machine Type Communication (mMTC) services, Integrated Sensing And Communication (ISAC), immersive communication, Ultra-massive Machine-Type Communication (uMTC), hyper reliable and low-latency communication, ubiquitous connectivity, integrated AI and communication, and other services that can be provided by a future generation communication system. The communication system 100 may provide other services and applications such as, but not limited to, earth monitoring, remote sensing, passive sensing and positioning, navigation and tracking, autonomous delivery and mobility and the like.

The communication system 100 may include a terrestrial communication system (or network) and/or a non-terrestrial communication system (or network). The communication system 100 may provide a high degree of availability and robustness through a joint operation of the terrestrial communication system and the non-terrestrial communication system. For example, integrating a non-terrestrial communication system (or components thereof) into a terrestrial communication system can result in a heterogeneous network comprising multiple layers. The heterogeneous network may achieve better overall performance through efficient multi-link joint operation, more flexible functionality sharing, and faster physical layer link switching between terrestrial networks and non-terrestrial networks. The terrestrial communication system and the non-terrestrial communication system could be considered as sub-systems of the communication system 100.

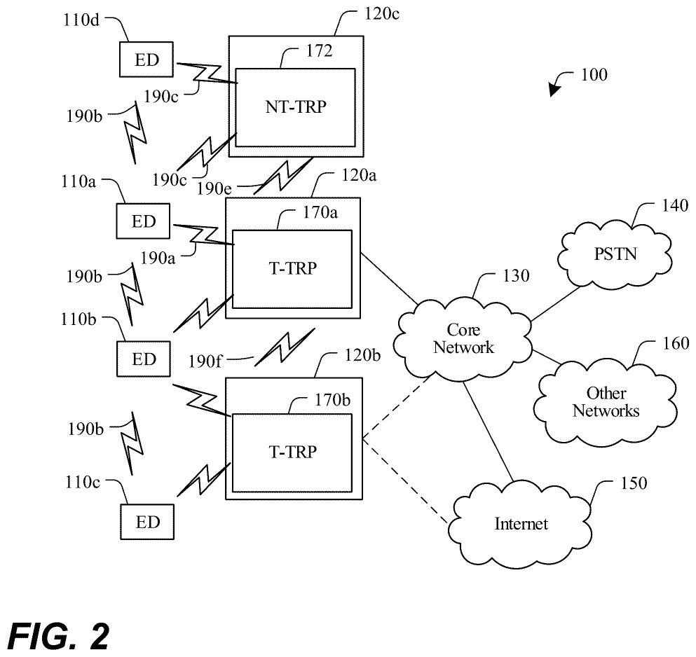

FIG. 2 illustrates a schematic illustration of another example communication system, in accordance with at least some non-limiting implementations of the present technology.

There is shown the communication system 100 which includes EDs 110a, 110b, 110c, 110d (collectively referred to as ED 110), RANs 120a, 120b, one or more CNs 130, a PSTN 140, the Internet 150, and other networks 160. Additionally, the communication system 100 may also include a non-terrestrial network (NTN) 120c. The RANs 120a and 120b may include network nodes 170a and 170b respectively.

Examples of network nodes 170a, 170b include base stations, which can be generally referred to as terrestrial network (TN) devices or terrestrial transmit and receive points (T-TRPs) 170a and 170b (collectively referred to as 170). In this context, the terms “TRP” and “base station” are used interchangeably unless otherwise specified. For simplicity, this disclosure primarily refers to network nodes as base stations; however, unless explicitly stated otherwise, references to TRP are considered non-limiting and interchangeable. The T-TRPs 170a, 170b may be base stations mounted on a building or tower.

In one implementation, the NTN 120c includes a RAN node such as a base station 172, which may be generally referred to as an NTN device, a non-terrestrial node, a non-terrestrial network device, a non-terrestrial base station, or a non-terrestrial transmit and receive point (NT-TRP) 172.

In some implementations, the NT-TRP 172 is not attached to the ground, for example, as in the case of an airborne base station. An airborne base station may be implemented using communication equipment supported or carried by a flying device. For example, a flying device may include, but is not limited to, an airborne platform (such as a blimp or an airship), balloon, drone (such as quadcopter), and other types of aerial vehicles.

In some implementations, an airborne base station may be supported or carried by an unmanned aerial system (UAS) or an unmanned aerial vehicle (UAV), such as a drone. An airborne base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station. High altitude platforms are yet another example of non-terrestrial base stations, including international mobile telecommunication base stations.

As referred to herein, and unless specified otherwise, a “TRP” may also refer to a T-TRP or an NT-TRP, a “T-TRP” may also refer to a “TN TRP”, and an “NT-TRP” may also refer to an “NTN TRP”. The NTN 120c may be considered a RAN, sharing operational aspects with RANs 120a, 120b. The NTN 120c may include at least one NTN device and at least one corresponding terrestrial network device. The at least one NTN device may function as a transport layer device and the at least one corresponding terrestrial network device may function as a RAN node, communicating with the ED 110 via the NTN device.

Additionally, there may be an NTN gateway on the ground (referred to as a terrestrial network device) that also functions as a transport layer device facilitating communication with both the NTN device and the RAN node. The RAN node may communicate with the ED 110 via the NTN device and the NTN gateway.

In some implementations, the NTN gateway and the RAN node may be located within the same device. A base station 170 (also referred to as a TRP as stated above) is a network element within a radio access network responsible for radio transmission and reception in one or more cells to or from the ED (such as a user equipment).

In different implementations, the base station 170 may also be known as a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a non-terrestrial node, a non-terrestrial network device, a non-terrestrial base station, and a positioning node, among other possibilities.

The base station 170 may be a macro base station (BS), a pico BS, a relay node, a donor node, or combinations thereof. When the base station 170 performs (or is configured to perform) a method described herein, it may be interpreted as the base station itself, one or more modules (or units) in the base station, a circuit or chip, or a combination thereof, performing the method. For example, the circuit or chip may include a modem chip, also referred to as a baseband chip, a system on chip (SoC) including a modem core, system in package (SIP)), and the like, and may be responsible for one or more communication functions within the base station.

The EDs 110a-110d and TRPs 170a-170b, 172 are examples of communication equipment configured to implement some or all of the operations and/or implementations described herein. The T-TRP 170a forms part of the RAN 120a, which may include other TRPs, and/or other devices. Also, the TRP 170b forms part of the RAN 120b, which may include other TRPs, and/or devices. Each TRP 170a, 170b may transmit and/or receive wireless signals within a particular geographic region or area, sometimes referred to as a “cell” or a “coverage area”.

The TRPs 170a-170b may be responsible for allocating and/or configuring resources and transmission and/or reception in a set of cell(s). A cell is a radio network object that can be uniquely identified by a cell identification that is broadcasted over a geographical region or area from base stations associated with the cell. A cell can work in either FDD or TDD mode. A cell may be further divided into cell sectors, and a base station 170a-170b may, for example, employ one or more transceivers to provide services to one or more sectors. Some implementations, may include pico or femto cells if supported by the radio access technology.

In some implementations, one or more transceivers could be used for each cell, such as with Multiple-Input Multiple-Output (MIMO) technology. The number of RANs 120a-120b shown is merely an example. Any number of RANs may be contemplated when designing the communication system 100.

A base station may be a single element, as shown in the figures, or multiple elements distributed throughout the corresponding RAN, or otherwise configured. In some implementations, a plurality of RAN nodes coordinate to assist the ED 110 in implementing radio access, and different RAN nodes separately implement and handle different functions of the base station. For example, the RAN node may be a central unit (CU), a distributed unit (DU), a CU-control plane (CP), a CU-user plane (UP), or a radio unit (RU) etc. The CU and the DU may be separately deployed, or included within the same element (i.e., a baseband unit (BBU)).

The RU may be included in a radio frequency device or a radio frequency unit (i.e., a remote radio unit (RRU), an active antenna unit (AAU), or a remote radio head (RRH)). In different systems, the CU (or the CU-CP and the CU-UP), the DU, or the RU may be known by different names, but their functions are understood by person skilled in the art. For example, in an open radio access network (ORAN) system, a CU may be referred to as an open CU (O-CU), a DU may be referred to as an open DU (O-DU), and a CU-CP may be referred to as an open CU-CP (O-CU-CP). The CU-UP may also be referred to as an open CU-UP (O-CU-UP), and the RU may also be referred to as an open RU (O-RU). Any one of the CU (or the CU-CP, the CU-UP), the DU, and the RU may be implemented using a software module, a hardware module, or a combination of a software module and a hardware module.

Furthermore, communication between different devices/apparatuses in various implementations of this disclosure may refer to direct communication (that is, without the need of forwarding by another device/apparatus), or may refer to communication(s) between different devices/apparatuses via another device/apparatus (that is, requiring forwarding by another device/apparatus). Alternatively, such communication(s) may involve one functional unit inside a device/apparatus using another functional unit within the device/apparatus to communicate with another device/apparatus. In other words, phrases such as “sending (or transmitting) information to . . . (an ED or a base station)” in this disclosure may be understood as a destination endpoint of the information being an ED or a base station, including, sending/transmitting information directly or indirectly to an ED or a base station. Similarly, phrases like “receiving information from . . . (an ED or a base station)” may be understood as a source endpoint of the information being an ED or a base station, including directly or indirectly receiving information from an ED or a base station.

Between the source endpoint that sends the information and the destination endpoint, necessary processing such as, but not limited to, format conversion, digital-to-analog conversion, amplification, and filtering may be performed on the information. However, the destination endpoint may understand valid information from the source endpoint. A similar understanding applies to other descriptions in this disclosure without reiterating details already described. In the present disclosure, the terms “send” and “transmit” may be used interchangeably in different implementations of this disclosure.

The ED 110 is used to connect people, objects, machines, and other entities. The ED 110 may be widely used in various scenarios including, but not limited to, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, and autonomous delivery and mobility.

Each ED 110 represents any suitable end user device for wireless operation and may include such devices (or may be referred to as, but not limited to) a user equipment (UE) or a user device or a terminal device, a wireless transmit/receive unit (WTRU), a mobile station, a fixed or mobile subscriber unit, a cellular telephone, a station (STA), an MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus (such as a module, modem, or chip) in the forgoing devices, among other possibilities. Future generation EDs 110 may be referred to by other terms.

When an ED 110 performs (or is configured to perform) a method described herein, it may be interpreted as the ED itself, one or more modules (or units) in the ED, a circuit or chip, or a combination thereof, performing the method. For example, the circuit or chip may include a modem chip, also referred to as a baseband chip, a system on chip (SoC) including a modem core, or system in package (SIP)), and the like, and may be responsible for one or more communication functions in the ED.

Each ED 110 connected to TRPs 170a-170b, and/or TRPs 172 can be dynamically or semi-statically turned-on (i.e., established, activated, or enabled), turned-off (i.e., released, deactivated, or disabled) and/or configured in response to one of more of: connection availability and connection necessity.

Any ED 110 may be alternatively or additionally configured to interface, access, or communicate with any of the TRPs 170a, 170b and 172, the Internet 150, the CN 130, the PSTN 140, the other networks 160, or any combination thereof. In some examples, the ED 110a may communicate an uplink (UL) and/or downlink (DL) transmission over a terrestrial air interface 190a with station-TRP 170a. In some examples, the EDs 110a, 110b, 110c, and 110d may also communicate directly with one another via one or more sidelink (SL) air interfaces 190b. In some examples, the EDs 110a, 110d may communicate using an UL and/or DL transmission over a non-terrestrial air interface 190c with NT-TRP 172.

An air interface (such as, for example, 190a, 190b, 190c) generally includes a number of components and associated parameters that collectively specify how a transmission is to be sent and/or received over a wireless communications link between two or more communicating devices such as EDs and base station(s). For example, an air interface may include one or more components defining the waveform(s), frame structure(s), multiple access scheme(s), protocol(s), coding scheme(s) and/or modulation scheme(s) for conveying information (such as, data) over a wireless communications link. The air interfaces 190a and 190b may use similar communication technology, that may include any suitable radio access technology.

The non-terrestrial air interface 190c can enable communication between the EDs 110a, 110d and one or more NT-TRPs 172 via a wireless link or simply a link. For some examples, the link is a dedicated connection for unicast transmission, a connection for broadcast transmission, or a connection between a group of EDs 110 and one or more NT-TRPs 172 for multicast transmission.

The TRPs 170a-170b, 172 may communicate with one another over one or more air interfaces 190e, 190f using wireless communication links (such as radio frequency (RF), microwave, infrared (IR), etc.) or wired communication links. The air interfaces 190e, 190f may utilize any suitable radio access technology, and may be substantially similar to the air interfaces 190a, 190c over which the EDs 110a-110d communicate with one or more of the TRP 170a-170b, 172 or they may be substantially different. For example, the communication system 100 may implement one or more channel access methods, such as Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA).

The RANs 120a and 120b are in communication with the CN 130 to provide the EDs 110a 110b, and 110c with various services such as voice, data, multimedia, and other services. The RANs 120a and 120b and/or the CN 130 may be in direct or indirect communication with one or more other RANs (not shown), which may or may not be directly served by the CN 130, and may employ different radio access technologies from RAN 120a and/or RAN 120b. The CN 130 may also serve as a gateway access between (i) the RANs 120a and 120b and/or the EDs 110a 110b, and 110c, and (ii) other networks (such as the PSTN 140, the Internet 150, and the other networks 160).

In addition, some or all of the EDs 110a 110b, and 110c may include functionality for communicating with different wireless networks over different wireless links using different wireless technologies and/or protocols. For example, the EDs 110a 110b, and 110c communicate using different cellular communications protocols, such as, but not limited to, a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like. Instead of wireless communication (or in addition thereto), the EDs 110a 110b, and 110c may communicate using wired communication channels to a service provider or switch (not shown), and/or to the Internet 150.

The PSTN 140 may include circuit switched telephone networks for providing plain old telephone service (POTS). The Internet 150 may include a network of computers and subnets (intranets) or both, and incorporate protocols, such as internet protocol (IP), transmission control protocol (TCP), user datagram protocol (UDP). EDs 110a 110b, and 110c may be multimode devices capable of operation according to multiple radio access technologies, and may incorporate one or multiple transceivers necessary to support such.

In addition, the communication system 100 may comprise a sensing agent (not shown) to manage the sensed data from ED 110 and/or any one of TRPs 170a, 170b, 172. In one implementation, the sensing agent may be part of any one of TRPs 170a, 170b, 172. In another implementation, the sensing agent is a separate node that can communicate with the CN 130 and/or the RAN 120 (such as any one of TRPs 170a, 170b, 172).

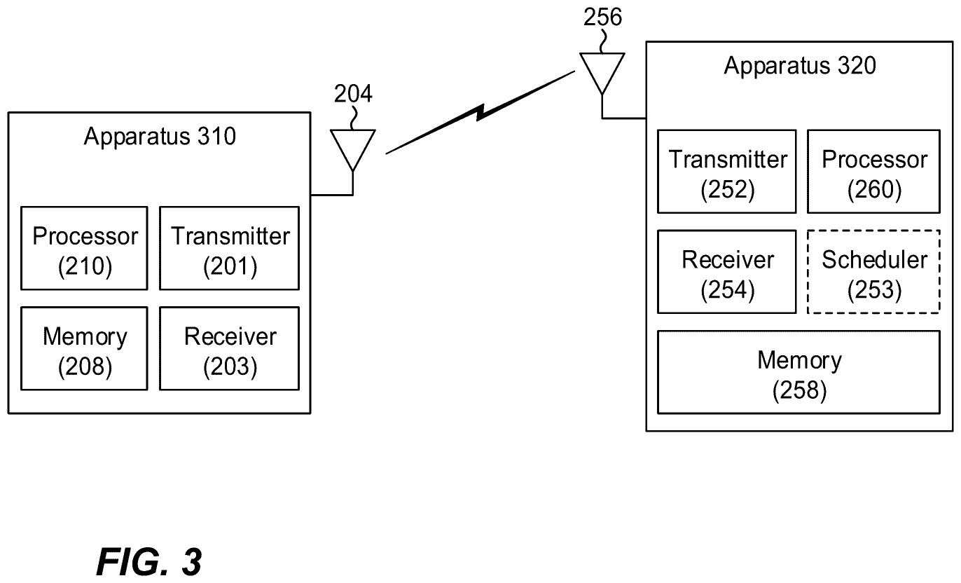

FIG. 3 illustrates a schematic illustration of an apparatus wirelessly communicating with another apparatus within a communication system, in accordance with at least some non-limiting implementations of the present technology.

The apparatus 310 may be an electronic device (such as ED 110). The apparatus 320 may be a network node (e, g., the network node 170) such as T-TRP 170 or an NT-TRP 172. Although only one apparatus 310, and one apparatus 320 are shown in the figure, the number of apparatus 310 and/or number of apparatus 320 can vary, potentially including one or more of each. For example, a single ED 110 may be served by a single T-TRP 170 (or a single NT-TRP 172), or by multiple T-TRPs 170 (or multiple NT-TRPs 172). Similarly, a single ED 110 may be served by one or more T-TRPs 170 and one or more NT-TRPs 172. Similarly, a single T-TRP 170 (or a single NT-TRP 172) may serve one or more EDs 110.

The apparatus 310 may include one or more processors 210. For clarity and to avoid overcrowding the illustration, only a single processor 210 is illustrated. The apparatus 310 may further include a transmitter 201 and a receiver 203 coupled to one or more antennas 204. For clarity, only a single antenna 204 is illustrated. One, some, or all of the antennas 204 may alternatively be panels.

In some implementations, the transmitter 201 and the receiver 203 are separate from each other. In other implementations, the transmitter 201 and the receiver 203 may be integrated into a single unit, for example, as a transceiver. The transceiver is configured to modulate data or other content for transmission by the one or more antennas 204 or a network interface controller (NIC). The transceiver may also be configured to demodulate data or other content received by the one or more antennas 204. A transceiver may include any suitable structure for generating signals for wireless or wired transmission and/or for processing signals received through wireless or wired communication. Each antenna 204 includes any suitable structure for transmitting and/or receiving wireless or wired signals. The apparatus 310 may include a memory 208. In some implementations, the apparatus 310 may include multiple memories 208.

Only a single transmitter 201, receiver 203, processor 210, memory 208, and antenna 204 is illustrated for simplicity, but the apparatus 310 may include one or more other components. In some implementations of the present disclosure, the transceiver (or transmitter 201 and/or receiver 203) may be viewed as an interface circuit.

The memory 208 is configured to store instructions used to perform operations described herein. The memory 208 may also be configured to store data that is used, generated, or collected by the apparatus 310. For example, the memory 208 can store software instructions or modules configured to implement some or all of the functionalities and/or operations described herein and that which are executed by the one or more processors 210.

The apparatus 310 may further include one or more input/output devices (not shown) or interfaces. The input/output devices or interfaces facilitate interaction with a user or other devices in the network. Each input/output device or interface includes suitable components for facilitating transmission of information to a user and reception of information from a user, and for various network interface communications. Such components may include, but are not limited to, a speaker, microphone, keypad, keyboard, display, touch screen, and the like.

The processor 210 may be configured to perform (or control the apparatus 310 to perform) operations (or methods) described herein as being performed by the apparatus 310. For example, the processor 210 performs or controls the apparatus 310 to perform the operations of: a) receiving one or more transport blocks (TBs), b) using a resource for decoding at least one of the received TBs, c) releasing the resource for decoding another of the received TBs, and/or d) receiving configuration information configuring a resource.

Specifically, the operations may include tasks related to: preparing a transmission for UL transmission to the apparatus 320, processing DL transmissions received from the apparatus 320, and handling SL transmission to and from another apparatus 310. Processing operations related to preparing a transmission for UL transmission may include operations such as, but not limited to, encoding, modulating, transmit beamforming, and generating symbols for transmission. Processing operations related to processing DL transmissions may include operations such as, but not limited to, receive beamforming, demodulating and decoding received symbols. Processing operations related to processing SL transmissions may include operations such as, but not limited to, transmit/receive beamforming, modulating/demodulating and encoding/decoding symbols. Depending upon the implementation, a DL transmission may be received by the receiver 203, possibly using receive beamforming, and the processor 210 may extract signaling from the DL transmission (such as by detecting and/or decoding the signaling). An example of signaling may be a reference signal transmitted by the apparatus 320.

In some implementations, the processor 210 implements the transmit beamforming and/or the receive beamforming based on the indication of beam direction, such as beam angle information (BAI), received from the apparatus 320. In some implementations, the processor 210 may be configured to perform operations relating to network access (such as initial access) and/or downlink synchronization, which includes operations for detecting a synchronization sequence, decoding and obtaining the system information, and the like. In some implementations, the processor 210 may perform channel estimation, such as using a reference signal received from the apparatus 320.

Although not illustrated, in some implementations, the processor 210 may either be a part of the transmitter 201 or a part of the receiver 203 or a part of both the transmitter 201 and the receiver 203. Although not illustrated, in some implementations, the memory 208 may be a part of the processor 210.

The processor 210, along with the processing components of the transmitter 201 and the receiver 203 may each be implemented by one or more processors that may the same or different. These processors are configured to execute instructions stored in a memory (such as in the memory 208).

The apparatus 320 includes one or more processors 260 (only one processor 260 is illustrated). The apparatus 320 may further include one or more transmitters 252 and one or more receivers 254 coupled to one or more antennas 256. Only a single antenna 256 is illustrated to avoid clutter in the illustration. One, some, or all of the antennas 256 may alternatively be panels. In some implementations, the transmitter 252 and the receiver 254 are separate from each other. In other implementations, the transmitter 252 and the receiver 254 may be integrated into a single unit such as, for example, as a transceiver.

The apparatus 320 may further include a memory 258. In some implementations, the apparatus 320 may include multiple memories 258. The apparatus 320 may further include a scheduler 253. Only a single transmitter 252, receiver 254, processor 260, memory 258, antenna 256 and scheduler 253 are illustrated for simplicity, however the apparatus 320 may include one or more other components. In the present disclosure, in some implementations, the transceiver (or transmitter 252 and/or receiver 254) may be viewed as an interface circuit.

In some implementations, various components of the apparatus 320 may be distributed. For example, some of the modules of the apparatus 320 may be located remotely from the equipment housing the antennas 256 for the apparatus 320 (and therefore also can be viewed as one or more nodes). These modules, which can be considered as one or more nodes, may be coupled to the equipment that houses the antennas 256 over a communication link (not shown), sometimes referred to as front haul, such as the Common Public Radio Interface (CPRI).

Therefore, in some implementations, the term apparatus 320 may also refer to network-side nodes that perform processing operations such as, but not limited to, determining the location of the apparatus 310, resource allocation (scheduling), message generation, and encoding/decoding, and that which are not necessarily part of the equipment that houses the antennas 256 of the apparatus 320. The nodes may also be coupled to other apparatuses 320. In some implementations, the apparatus 320 may actually be a plurality of nodes that are operating together to serve the apparatus 310, such as through the use of coordinated multipoint transmissions, or through the use of ORAN system as described above in the disclosure.

The processor 260 is configured to perform operations including those related to: preparing a transmission for DL transmission to the apparatus 310, processing an UL transmission received from the apparatus 310, preparing a transmission for backhaul transmission to another apparatus 320, and processing a transmission received over backhaul from another apparatus 320. Processing operations related to preparing a transmission for DL or backhaul transmission may include operations such as, but not limited to, encoding, modulating, precoding (such as MIMO precoding), transmit beamforming, and generating symbols for transmission.

Processing operations related to processing received transmissions in the UL or over backhaul may include operations such as, but not limited to, receive beamforming, demodulating received symbols, and decoding received symbols. The processor 260 may also be configured to perform operations relating to network access (such as initial access) and/or DL synchronization, such as generating the content of synchronization signal blocks (SSBs), generating the system information, and the like. In some implementations, the processor 260 is further configured to generate an indication of beam direction, such as BAI, which may be scheduled for transmission by the scheduler 253 which will be described below.

In some implementations, the processor 260 implements the transmit beamforming and/or receive beamforming based on beam direction information (such as BAI) received from another apparatus 320. The processor 260 is configured to perform other network side processing operations described herein, such as, but not limited to, determining the location of the apparatus 310, determining where to deploy another apparatus 320, and the like. In some implementations, the processor 260 may generate signaling data, to configure one or more parameters of the apparatus 310 and/or one or more parameters of another apparatus 320. Any signaling data generated by the processor 260 is sent by the transmitter 252. In some implementations, the apparatus 320 implements physical layer processing.

In some implementations, the apparatus 320 may perform higher layer functions such as those at the Medium Access Control (MAC) or Radio Link Control (RLC) layers in addition to physical layer processing. In the apparatus 320, the scheduler 253 may be coupled to the processor 260 or integrated within the processor 260. In some implementations, the scheduler 253 may be integrated within the apparatus 320 or may be operated separately from the apparatus 320. The scheduler 253 may schedule UL, DL, SL, and/or backhaul transmissions, including issuing scheduling grants and/or configuring scheduling-free (such as “configured grant”) resources.

The apparatus 320 may further include a memory 258 that is configured to store instructions for performing the operations described herein. The memory 258 may also store data that is used, generated, or collected by the apparatus 320. For example, the memory 258 can store software instructions or modules configured to implement some or all of the functionalities and/or implementations described herein and that which are executed by the processor 260.

Although not illustrated, the processor 260 may be implemented as part of the transmitter 252 and/or a part of the receiver 254. Although not illustrated, in some implementations, the processor 260 may implement the scheduler 253 and the memory 258 may be implemented as part of the processor 260.

The processor 260, the scheduler 253, the processing components of the transmitter 252, and the processing components of the receiver 254 may each be implemented by the same or different processors that are configured to execute instructions stored in a memory, such as in the memory 258. The apparatus 320 and/or the apparatus 310 may include other components, not shown or described herein for the sake of clarity.

Note that the term “signaling”, as used herein, may alternatively be referred to as control signaling, control message, control information, or message for simplicity. Signaling between a base station (such as the TRP 170a. 170b, 172) and a UE or sensing device (such as ED 110), or signaling between a different UE or sensing device (such as between ED 110a and ED 110b) may be carried in physical layer signaling (also called as dynamic signaling), which is transmitted in a physical layer control channel.

For DL, the physical layer signaling may be known as downlink control information (DCI) which is transmitted in a physical downlink control channel (PDCCH). For UL, the physical layer signaling may be known as uplink control information (UCI) which is transmitted in a physical uplink control channel (PUCCH). For SL, signaling between different UEs or sensing devices (such as between ED 110a and ED 110b) may be known as SL control information (SCI) which is transmitted in a physical sidelink control channel (PSCCH).

Signaling may be carried in a higher layer (such as higher than physical layer) signaling, which is transmitted in a physical layer data channel, such as in a physical downlink shared channel (PDSCH) for downlink signaling, in a physical uplink shared channel (PUSCH) for uplink signaling, and in a physical sidelink shared channel (PSSCH) for SL signaling. Higher layer signaling may also be called static signaling, or semi-static signaling. The higher layer signaling may include radio resource control (RRC) protocol signaling or media access control-control element (MAC-CE) signaling. Signaling may be included in a combination of physical layer signaling and higher layer signaling.

It should be noted that in the present disclosure, “information”, when different from “message”, may be carried within a single message, or may be carried in multiple separate messages.

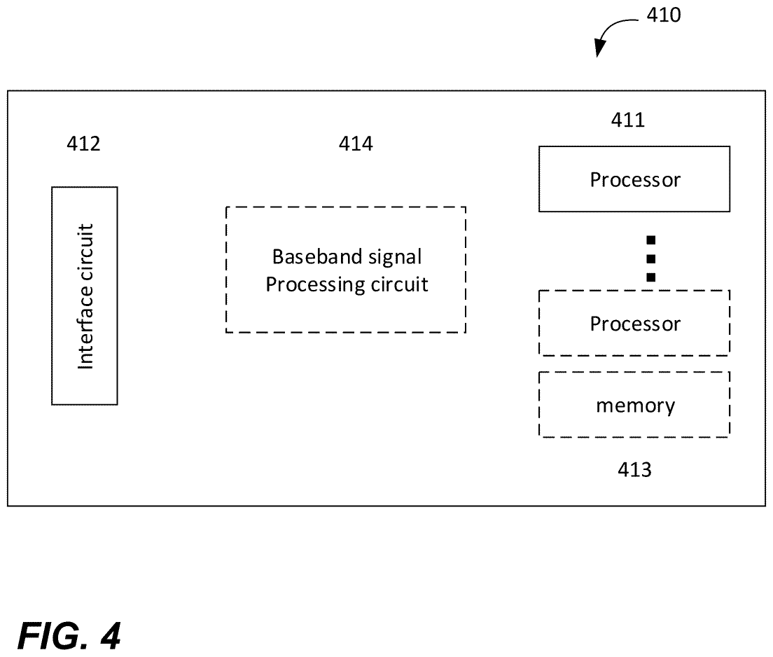

FIG. 4 illustrates a schematic illustration of an example apparatus, in accordance with at least some non-limiting implementations of the present technology.

The apparatus 410 may be a communication device or an apparatus implemented in a communication device such as the ED 110 or the TRPs 170a, 170b, 172. For example, the apparatus 410 implemented in an ED may be an integrated circuit, which in some instances may be referred to as a chip, a modem, a modem chip, a baseband chip, or a baseband processor. In some implementations, one or more integrated circuits can be packaged into a system-on-chip, a system-in-package, or a multi-chip module.

The apparatus 410 can include one or more integrated circuits and other discrete components. In some implementations, the apparatus 410 may be a module within the ED 110, or within the apparatus 310. In some implementations, the apparatus 410 may be a module within one of the TRPs 170a, 170b, 172, or the apparatus 320.

In an example, the apparatus 410 may include one or more processors 411, and an interface circuit 412. The apparatus 410 may further include a memory 413. The one or more processors 411 are configured to process signals and execute one or more communication protocols. The memory 413 is configured to store at least a part of corresponding computer program instructions and/or data.

In an example, the one or more processors 411 execute the computer program instructions stored in the memory 413 to implement related operations (for example, inputting, outputting, receiving, and transmitting) in the method implementations disclosed herein. In some implementations, the memory 413 being configured to store the corresponding computer program instructions and/or data may mean that the memory 413 is configured to store all of the corresponding computer program instructions and/or data for execution by the one or more processors 411.

In some implementations, the memory 413 being configured to store the corresponding computer program instructions and/or data may mean that the memory 413 is configured to store a part of the corresponding computer program instructions and/or data. For example, the part of the corresponding computer program instructions and/or data may include computer program instructions and/or data that need to be currently executed by the one or more processors 411. Thus, the memory 413 may store different parts of computer program instructions and/or data for a plurality times for the one or more processors 411 to perform related operations in the method implementations disclosed herein. As a communication interface, the interface circuit 412 is configured to implement communication with another component.

For example, the interface circuit 412 may communicate a signal with another apparatus or system, such as a radio frequency processing apparatus or another processor. The signal may include or carry information intended as a payload, such as user data, control information, etc. The signal may also include or carry information useful to a receiver, but not necessarily as a payload, such as a pilot signal or reference signal. Communicating the signal may include transmitting the signal to another component or device. Communicating the signal may additionally or alternatively include receiving the signal from another component or device.

Transmitting the signal may include outputting the signal to a component or device that is directly or indirectly coupled to the interface circuit 412. Receiving the signal may include inputting or obtaining the signal from a component or device that is directly or indirectly couped to the interface circuit 412. Optionally, to reduce a load of the one or more processors, a baseband signal processing circuit 414 may be also disposed to implement processing of at least a part of baseband signals, including signal demodulation, modulation, encoding, decoding, or the like.

The apparatus 410 may be the processor 210 (or 260) within the apparatus 310 (or 320), in some scenarios, or may be included within the processor 210 (or 260) within the apparatus 310 (or 320) in some scenarios. The apparatus 410 may be a baseband chip or may include a baseband chip. In some implementations, the apparatus 410 may be independently packaged into a chip. In some implementations, the apparatus 310 (or 320) includes different types of chips. The apparatus 410 may be packaged into a processor chip (for example, an SoC chip or an SIP chip) with the different types of chips. In some implementations, the apparatus 410 may be packaged into a chip with some or all of circuits of a radio frequency processing system that may further be included in the apparatus 310 (or 320).

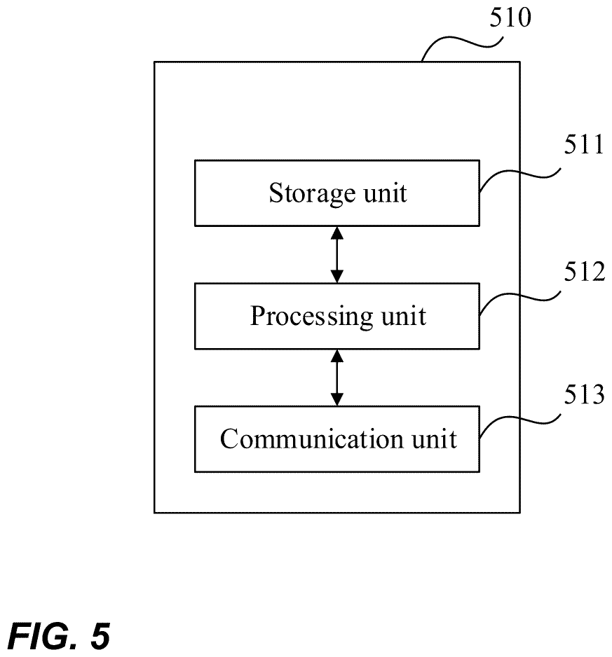

FIG. 5 illustrates a schematic illustration of another example apparatus, in accordance with at least some non-limiting implementations of the present technology. The apparatus 510 may include corresponding modules or units configured to implement methods and/or implementations described herein. In some implementations, the apparatus 510 includes a processing unit 512 and a communication unit 513. Optionally, the apparatus 510 may further include a storage unit 511 configured to store apparatus program code (or instructions) and/or data.

The apparatus 510 may be an ED side apparatus, for example, an ED or a module in an ED, or a circuit or a chip responsible for a communication function in an ED. In some implementations, apparatus 510 may be the apparatus 310. The processing unit 512 may be the processor 210. The communication unit 513 may comprise a receiving unit and/or a transmitting unit. The receiving unit and/or the transmitting unit may be the transmitter 201 and/or the receiver 203 respectively. The storage unit 511 may be the memory 208.

The apparatus 510 may be a base station side apparatus, for example, a base station or a module in a base station, or a circuit or a chip responsible for a communication function in a base station. In some implementations, apparatus 510 may be apparatus 320. The processing unit 512 may be the processor 260 (the scheduler 253 may also be included). The communication unit 513 may comprise a receiving unit and/or a transmitting unit. The receiving unit and/or the transmitting unit may be the transmitter 252 and/or the receiver 254 respectively. The storage unit 511 may be the memory 258.

In some implementations, when the apparatus 510 is an ED 110 or a module in an ED 110, a function of the apparatus 510 may be implemented by one or more processors. Specifically, the processor may include a modem chip, or a system on chip (SoC) chip or an SIP chip that includes a modem core. A function of the communication unit 513 may be implemented by a transceiver circuit.

In some implementations, when the apparatus 510 is a circuit or a chip that is responsible for a communication function in an ED 110,—such as a modem chip, a system on chip (SoC) chip or an SIP chip that includes a modem core—a function of the processing unit 512 may be implemented by a circuit system within the chip which includes one or more processors. A function of the communication unit 513 may be implemented by an interface circuit or a data transceiver circuit on the chip.

It may be understood that the units in the apparatus 510 may be logical or functional. Each function may correspond to one functional unit, or two or more functions may be integrated into a single functional unit. In actual implementation, all or some of the units may be integrated into a single physical entity, or may be distributed across different physical entities. In addition, the functional units may be implemented in the form of hardware, software, or a combination of hardware and software. Whether a function is implemented in the form of hardware or software depends on particular applications and design constraint conditions of the technical solutions. A person skilled in the art may use different methods to implement the described functions for specific applications, but it should not be considered that the implementation goes beyond the scope of this disclosure.

In an example, a functional unit in any one of the apparatuses may be configured as one or more integrated circuits for implementing the methods disclosed herein, for example, as one or more application-specific integrated circuits (application-specific integrated circuits, ASICs), one or more central processing units (CPUs), one or more microprocessors or microprocessor units (MPUs), one or more microcontrollers or microcontroller units (MCUs), one or more digital signal processors (DSPs), one or more field programmable gate arrays (FPGAs), or a combination of these.

In an example, the storage unit 511 may include a random access memory, a flash memory, a read-only memory, a programmable read-only memory, an electrically erasable programmable memory, and/or a register.

A processor may be referred to as a processor system, an application processor, a baseband processor, a processor circuit, or a processor core. The processor may include one or a combination of one or more central processing units (CPUs), one or more digital signal processors (DSPs), one or more microprocessors (microprocessor units, MPUs), one or more microcontrollers (microcontroller units, MCUs), one or more graphics processing units (GPUs), one or more field programmable gate arrays (FPGAs), one or more artificial intelligence processors (AI processors), or one or more neural network processing units (NPUs).

Memory or a storage unit may include one or more of the following storage media: a random access memory (RAM), a static random access memory (static RAM, SRAM), a dynamic random access memory (dynamic RAM, DRAM), a phase-change memory (PCM), a resistive random access memory (resistive RAM, ReRAM), a magnetoresistive random access memory (magnetoresistive RAM, MRAM), a ferroelectric random access memory (ferroelectric RAM, FRAM), a cache, a register, a read-only memory (ROM), a flash memory (flash memory), an erasable programmable read-only memory (erasable programmable ROM, EPROM), a hard disk, and the like. In an example, computer program instructions used to execute embodiments may be stored in a non-volatile memory, for example, at least a part of a memory or storage unit (for example, one or more of a ROM, a flash memory, an EPROM, or a hard disk). When a terminal runs, a part or all of corresponding computer program instructions may be loaded to a memory that has a higher transmission speed with the processor, for example, at least a part of a memory or a storage unit (for example, one or more of a RAM, an SRAM, a DRAM, a PCM, a RERAM, an MRAM, a FRAM, a cache, or a register), so that the processor executes the computer program instructions to perform the steps in the method embodiments disclosed herein.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (such as data) over a wireless communications link. The wireless communications link may support a link between a radio access network and user equipment (such as a “Uu” link), and/or the wireless communications link may support a link between devices, such as between two user equipment (such as a “sidelink”), and/or the wireless communications link may support a link between a non-terrestrial (NT)-communication network and a user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, such as via a dedicated channel resource (such as no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some implementations, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple-input multiple-output (MIMO) mode, can be configured. In some embodiments, an air interface design may provide a unified or flexible framework to support frequencies below 6 GHz and beyond 6 GHz (such as mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

A frame structure is a feature of the wireless communication physical layer that defines a time domain signal transmission structure, such as to allow for timing reference and timing alignment of basic time domain transmission units. Wireless communication between communicating devices may occur on time-frequency resources governed by a frame structure. The frame structure may sometimes be referred to as a radio frame structure.

Depending upon the frame structure and/or configuration of frames in the frame structure, frequency division duplex (FDD) and/or time-division duplex (TDD) and/or full duplex (FD) communication and/or half duplex (HD) may be possible. FDD communication involves transmitting in different directions (e.g., uplink and downlink) on different frequency bands. TDD communication involves transmitting in different directions (e.g., uplink and downlink) over different time durations. FD communication involves simultaneous transmission and reception on the same time-frequency resource, allowing a device to transmit and receive concurrently on the same frequency resource. HD communication involves alternately transmitting and receiving on a time-frequency resource, and does not allow simultaneous transmission and reception.

In an example, the frame structure may follow the specifications of a Long-Term Evolution (LTE) frame structure, which includes the following: each frame is 10 ms in duration; each frame has 10 subframes, each of which is 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

In another example, the frame structure may follow the specifications of a New Radio (NR) frame structure which includes the following: multiple subcarrier spacings are supported, each subcarrier spacing corresponding to a respective numerology; the frame structure depends on the numerology, but the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

In yet another example, the frame structure may be a flexible frame structure for use in a future network or later. In a flexible frame structure, a symbol block may be defined as the minimum duration of time that may be scheduled in the flexible frame structure. A symbol block may be a unit of transmission having an optional redundancy portion (such as CP portion) and an information (such as data) portion. An OFDM symbol is an example of a symbol block. A symbol block may alternatively be called a symbol. Implementations of flexible frame structures include different parameters that may be configurable, such as frame length, subframe length, symbol block length, and the like. A non-exhaustive list of possible configurable parameters in some embodiments of a flexible frame structure include:
Frame: The frame length can be, but need not be limited to 10 ms, and the frame length may be configurable and can change over time. In some implementations, each frame includes one or more downlink synchronization channels and/or one or more downlink broadcast channels, and each synchronization channel and/or broadcast channel may be transmitted in different directions using different beamforming techniques. The value of frame length can vary and is configured based on the application scenario. For example, autonomous vehicles may require relatively fast initial access, in which case the frame length may be set as 5 ms for these applications. As another example, smart meters on houses may not require fast initial access, in which case the frame length may be set as 20 ms for these applications.
Subframe duration: A subframe may or may not be defined in the flexible frame structure, depending on the implementation. For example, a frame may be defined to include slots, but no subframes. For frames where a subframe is defined, such as for time domain alignment, the duration of the subframe may be configurable. For example, a subframe may be configured to have a length of 0.1 ms, 0.2 ms, 0.5 ms, 1 ms, 2 ms, 5 ms, etc. In some implementations, if a subframe is not needed for a particular scenario, the subframe length may be defined to be the same as the frame length or may not be defined at all.
Slot configuration: A slot may or may not be defined in the flexible frame structure, depending on the implementation. For frames where a slot is defined, the definition of a slot (such as in terms of time duration and/or number of symbol blocks) may be configurable. In some implementations, the slot configuration is common to all UEs or a group of UEs. For this case, the slot configuration information may be transmitted to UEs in a broadcast channel or common control channel(s). In other implementations, the slot configuration may be UE specific, in which case the slot configuration information may be transmitted in a UE-specific control channel. In some implementations, the slot configuration signaling can be transmitted together with frame configuration signaling and/or subframe configuration signaling. In other implementations, the slot configuration can be transmitted independent from the frame configuration signaling and/or subframe configuration signaling. In general, the slot configuration may be system wide, common to a base station, common to a UE group, or specific to an individual UE.
Subcarrier spacing (SCS): SCS is a parameter of scalable numerology which can range from 15 KHz to 480 KHz. The SCS may vary with the frequency of the spectrum and/or the maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, such as in the case where more flexible symbol durations are implemented using inverse discrete Fourier transform (IDFT) instead of fast Fourier transform (FFT). Additional examples of frame structures can accommodate different SCS. (5) Flexible transmission duration of basic transmission unit: The basic transmission unit, referred to as a symbol block (or a symbol), generally includes a redundancy portion (referred to as the CP) and an information portion (such as data). In some implementations, the CP may be omitted from the symbol block. The CP length may be fixed or may be flexible and configurable. For example, the CP length may either be fixed within a frame or vary within a frame, and the CP length may change from one frame to another, or from one group of frames to another group of frames, or from one subframe to another subframe, or from one slot to another slot, or dynamically from one scheduling period to another scheduling period. The information portion may also be flexible and configurable. Another parameter that may be defined for a symbol block is the ratio of CP duration to information (data) duration. In some implementations, the symbol block length may be adjusted based on factors such as, but not limited to, channel conditions (e.g., multi-path delay, Doppler effects), latency requirements, and available time duration. For example, a symbol block length may be adjusted to fit an available time duration within the frame.
Flexible switch gap: A frame may include both a downlink portion for downlink transmissions from a base station, and an uplink portion for uplink transmissions from UEs (or EDs). A switching gap may be present between each uplink and downlink portion. The switching gap refers to a period of time within a communication frame that separates uplink transmissions from downlink transmissions. This gap allows the transition between receiving and transmitting modes in the communication system, particularly in time-division duplex (TDD) systems where the same frequency channel is used for both uplink and downlink communications, but at different times. The length or duration of the switching gap may be configurable. A switching gap duration may be fixed within a frame, configurable within a frame, may possibly change from one frame to another, from one group of frames to another group of frames, from one subframe to another subframe, from one slot to another slot, or dynamically from one scheduling period to another scheduling period.

A device, such as a base station, may provide coverage over a cell. Wireless communication with the device may occur over one or more carrier frequencies, referred to as carriers. A carrier, also known as a component carrier (CC), may be characterized by its bandwidth and a reference frequency, such as the center, lowest or highest frequency of the carrier. A carrier may be on licensed or unlicensed spectrum. Wireless communication with the device may also occur over one or more bandwidth parts (BWPs). For example, a carrier may have one or more BWPs. More generally, wireless communication with the device may occur over a spectrum. The spectrum may comprise one or more carriers and/or one or more BWPs.

A cell may include one or more downlink resources and optionally one or more uplink resources, or a cell may include one or more uplink resources and optionally one or more downlink resources. Alternatively, a cell may include both one or more downlink resources and one or more uplink resources. For example, a cell may include one downlink carrier/BWP, one uplink carrier/BWP, multiple downlink carriers/BWPs, multiple uplink carriers/BWPs, one downlink carrier/BWP and one uplink carrier/BWP, one downlink carrier/BWP and multiple uplink carriers/BWPs, multiple downlink carriers/BWPs and one uplink carrier/BWP, multiple downlink carriers/BWPs and multiple uplink carriers/BWPs. In some implementations, a cell may also include one or more sidelink resources, including sidelink transmitting and receiving resources.

A BWP is a set of contiguous or non-contiguous frequency subcarriers on a carrier, a set of contiguous or non-contiguous frequency subcarriers on multiple carriers, or a set of non-contiguous or contiguous frequency subcarriers, which may have one or more carriers.

In some implementations, a carrier may have one or more BWPs—for example, a carrier may have a bandwidth of 20 MHz and consist of one BWP, or a carrier may have a bandwidth of 80 MHz and consist of two adjacent contiguous BWPs. In other implementations, a BWP may have one or more carriers for example, a BWP may have a bandwidth of 40 MHz and consists of two adjacent contiguous carriers, where each carrier has a bandwidth of 20 MHz. In some implementations, a BWP may include non-contiguous spectrum resources across non-contiguous multiple carriers, where a first carrier of the non-contiguous multiple carriers may be in mmWave band, a second carrier may be in a low band (such as a 2 GHz band), the third carrier (if it exists) may be in the THz band, and the fourth carrier (if it exists) may be in a visible light band. Resources within a BWP on a single carrier may be contiguous or non-contiguous.

Wireless communication may occur over an occupied bandwidth, which may be defined as the width of a frequency band where, beyond the lower and the upper frequency limits, the mean emitted powers are each equal to a specified percentage (β/2) of the total mean transmitted power. (e.g., β/2=0.5%).

The carrier, BWP, or the occupied bandwidth may be signaled by a network device (such as a base station) dynamically, such as via physical layer control signaling (e.g., DCI), or semi-statically, such as via radio resource control (RRC) signaling or via the medium access control (MAC) layer, or be predefined based on the application scenario, determined by the UE as a function of known parameters, or fixed by a standard.

User equipment (UE) position information is often used in cellular communication networks to improve various performance metrics in the network. Such performance metrics may include, but are not limited to, capacity, agility, and efficiency. Improvements to the performance metrics may be achieved when elements of the network exploit parameters such as, but not limited to, the position, behavior, and mobility patterns, of the UE in the context of a priori information describing a wireless environment in which the UE is operating.

A sensing system may be used to help gather pose information associated with the UE, including one or more of its location in a global coordinate system such as, but not limited to, the Global Positioning System (GPS), the World Geodetic System 1984 (WGS 84), the International Terrestrial Reference System (ITRS), the Universal Transverse Mercator (UTM), the Earth-Centered, Earth-Fixed (ECEF) Coordinate System, or the Geographic Coordinate System (latitude, longitude, altitude) for both 2D and 3D positioning, its velocity and direction of movement in the global coordinate system, orientation information, and the information about the wireless environment. “Location” may also be known as “position”—these two terms may be used interchangeably herein. Examples of the sensing system may include, but is not limited to, RADAR (Radio Detection and Ranging) and LIDAR (Light Detection and Ranging). While the sensing system can be separate from the communication system, it can be advantageous to gather information using an integrated system, which reduces the amount of hardware used, and therefore the cost as well as the time, frequency, or spatial resources needed to perform both functionalities. However, using the communication system hardware to for sensing UE pose and environment information is a highly challenging and unresolved problem. The difficulty of this problem relates to factors such as, but not limited to, the limited resolution of the communication system, the dynamicity of the environment, and the huge number of objects whose electromagnetic properties and position need to be estimated.

Accordingly, integrated sensing and communication (also known as integrated communication and sensing) is a desirable feature in existing and future communication systems.

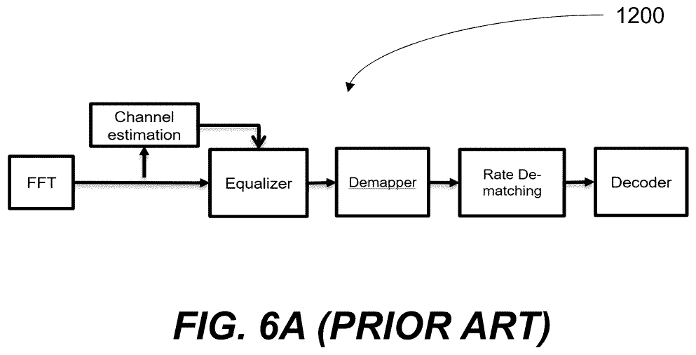

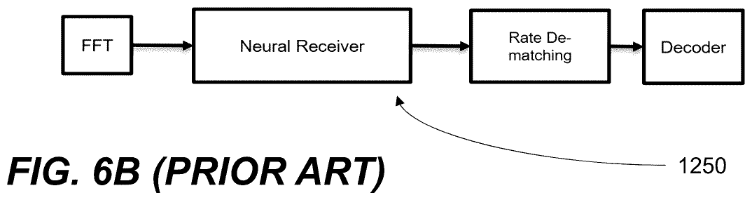

With reference to FIG. 6A there is depicted a processing pipeline 1200 employing a receiver in a “deterministic” configuration. In the processing pipeline 1200, one or more pilot signals from a resource are used to estimate channels of every symbol in that grid. So-estimated channels can be used to equalize the symbols. A demapper is implemented to calculate log-likelihood ratios (LLRs) of the bits. Channel estimation can be performed using a Least Square (LS) technique, and an equalizer may be implemented using a linear minimum mean square error (LMMSE) technique. Developers of the present technology have realized that receivers in the traditional configuration may have comparatively low bit error ratio (BER) performance, if compared to an ideal receiver in which optimal channels are apriori known, for example.

With reference to FIG. 6B there is depicted a processing pipeline 1250 employing a deep learning receiver in a “neural” configuration. The deep learning receiver can have a neural network architecture that is configured to jointly estimate channels, equalize symbols, and demap the symbols into soft bits.

Developers of the present technology have realized that BER performance of receivers in the neural configuration can fluctuate based on inter alia the input distribution. More specifically, if the input distribution is similar the distribution of a corresponding training data set, a receiver in the neural configuration may perform comparatively better than a receiver in the traditional configuration. However, if the input distribution is far from the distribution of the training data set, the receiver in the neural configuration may have a comparatively lower performance than the receiver in the traditional configuration. Even if aa neural receiver is trained over many channel distributions, there may be other distributions for which the receiver in the traditional configuration may outperform the receiver in the neural configuration.

It should be noted that adaptive learning techniques may require higher computational demands of online training, require true labels during each shift, and cause issues with early distribution shift detection.

Developers of the present technology have realized that receivers in the traditional configuration employ non-optional techniques for channel estimation, equalization, and de-mapping functions. In addition, the gap between a given performance and the optimal performance is significant. Employing deep learning-based approaches may reduce, in some scenarios, a difference between current performance and an optimal performance, while in other scenarios, may increase the difference. This is due to wireless channels being dynamic and changing their behaviors with time, frequency and/or space. In general, the trained deep learning receivers are limited by the training data set distributions and may not fully generalize to unseen distributions. It should be noted that a trained deep learning receiver may generalize to unseen samples that follow the same training data set distribution but may be ill-suited to generalize for unseen input distributions.

In some embodiments of the present technology, there is provided a hybrid receiver in a “hybrid” configuration that may leverage advantages of receivers in the traditional configuration and receivers in the neural configuration. Instead of replacing the receiver functions in the traditional configuration, a neural receiver is integrated for aiding in improving the overall receiver performance. If the received OFDM block (or resource grid) is in the knowledge domain of the neural receiver, the hybrid receiver may be configured to handle the OFDM block by the neural receiver—or otherwise, the hybrid receiver may employ the receiver in the traditional configuration.

In some embodiments, domain knowledge of neural receivers and traditional receivers may be distilled into a “discriminator” neural network (NN). Particularly, once the neural receiver is trained, a dataset is generated where the inputs consist of one or more pilot signals, and output is assigned as 1 if the number of error bits from the neural receiver is less than that of the traditional receiver; otherwise, it is assigned as 0. This dataset will be then used to train the discriminator NN to select a target receiver for each received OFDM block. The discriminator NN in may be used to evaluate capabilities and/or limitations of both receivers and/or determine whether the input distribution aligns with the neural receiver or not. It should be noted that during the data set generation, some samples are generated are represent anomalous instances, where the neural receiver underperforms. The distribution of anomalies can be selected under the condition that they are highly unlikable to be received in the real systems (e.g., very high value of delay spread). Developers have realized that injecting the data sets from one unknown channel distribution to the neural receiver makes the discriminator perform well for a variety of different channel scenarios.

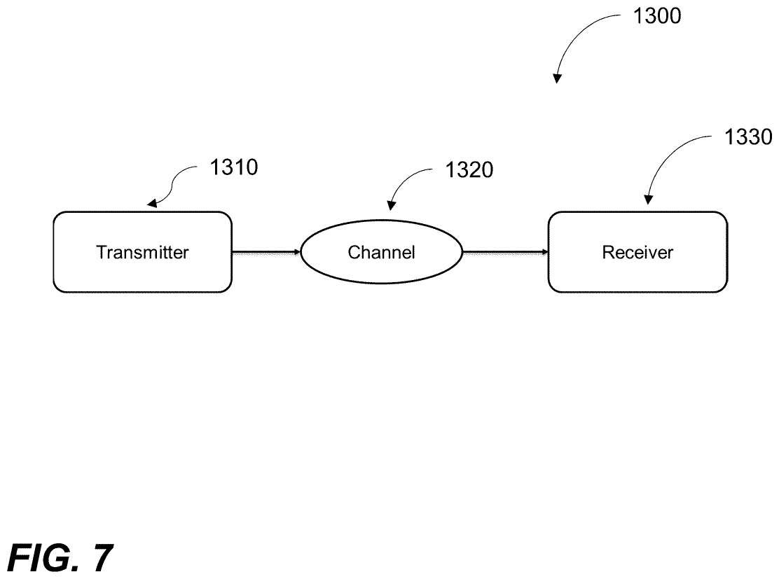

With reference to FIG. 7, there is depicted a communication system 1300 as contemplated in the context of the present technology. The communication system 1300 comprises a transmitter 1310, channels 1320, and a hybrid receiver 1330. In some embodiments the hybrid receiver 1330 may be a wireless receiver with one or more functions of a traditional receiver and one or more functions of a neural receiver. It should be noted that the channel 1320 in wireless communication changes with time, frequency, and/or space. These changes can occur rapidly in mobile transmitter and/or receiver, and/or when the environment around the transmitter and/or the receiver is changing.

As it will be described in greater details herein further below, in a first embodiment of the hybrid receiver 1330, data processing paths are selected at the beginning of the pipeline via a discriminator NN used to selectively employ either the neural receiver or the traditional functions for generating the LLRs. In a second embodiment of the hybrid receiver 1330, the received signal may be first processed by the traditional functions and the discriminator NN is used to selectively determine whether the neural receiver is to be further used or not. In a second embodiment of the hybrid receiver 1330, the received signal may first be handled by the neural receiver and then the discriminator NN may be used for selectively determining whether to selectively employ the traditional functions or not.

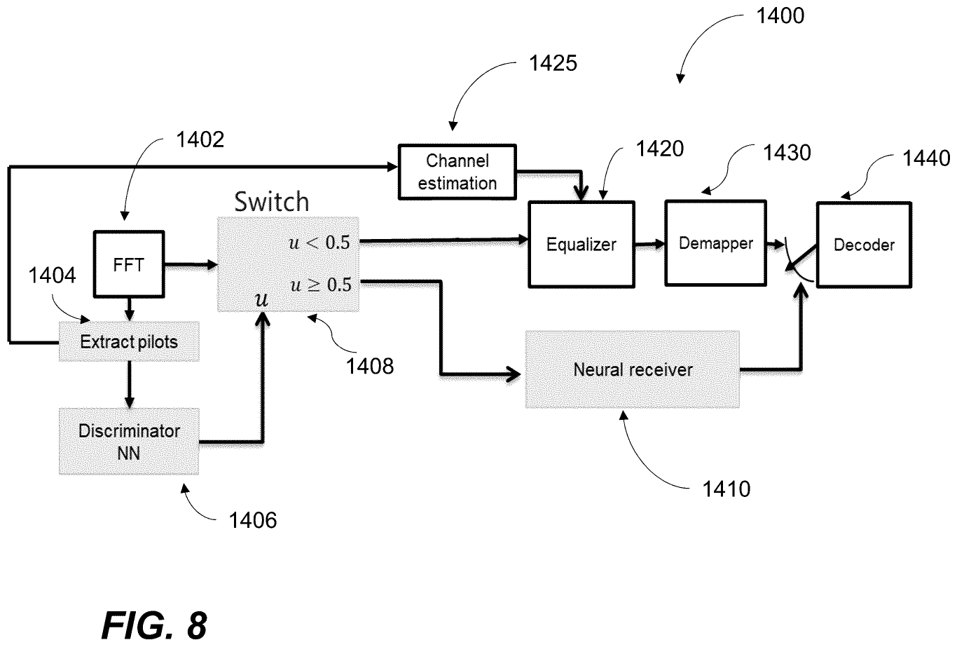

With reference to FIG. 8, there is depicted a processing pipeline 1400 of the hybrid receiver 1330 in accordance with a first embodiment of the present technology.

The hybrid receiver 1400 may operate in the frequency domain. Initially, the time-domain received signals can be converted to frequency-domain signals using a Fast Fourier Transform (FFT) module 1402. The received signals may be structured in an Orthogonal Frequency Division Multiplexing (OFDM) resource grid, where each resource grid can include pilot signals. The locations of these pilot signals may be known to the receiver, enabling the extraction of pilot signals via the Extract pilots module 1404. These extracted pilot signals can then be fed into the discriminator neural network (NN) 1406.

The discriminator NN 1406 may generate a value, denoted as u, which can range between 0 and 1. This value can represent the probability of using the neural receiver 1410 for detecting soft bits (e.g., Log-Likelihood Ratios or LLRs). The output u may then be forwarded to a switching mechanism 1408, which can direct the received resource grid to either the neural receiver 1410 if u≥0.5, or to the deterministic receiver or processing path (comprising channel estimation 1425, equalizer 1420, and demapper 1430) if u<0.5.

If the neural receiver 1410 is employed, it may reshape the resource grid to match its input shape before processing it through its layers to produce the LLRs. The output of the neural receiver 1410 can be compatible with the decoder 1440, which may process the LLRs for further operations. The switching mechanism 1408 may also ensure that the rate matcher connects either to the output of the neural receiver 1410 (for u≥0.5) or to the output of the deterministic demapper 1430 (for u<0.5).

Both the neural receiver 1410 and the discriminator NN 1406 may be neural networks. The discriminator NN can be designed to be smaller in size compared to the neural receiver and may be optimized to minimize the resulting bit error rate (BER).

The Extract pilots module 1404 may extract the pilot signals from the resource grid and reshape them to match the input shape required by the discriminator NN 1406. The discriminator NN 1406 can be a compact neural network trained to discriminate inputs based on the neural receiver's capability to process the signals. The switch 1408 may forward the received resource grid to either the neural receiver 1410 or the deterministic receiver based on the value of u. The neural receiver 1410 may process the received symbols in the resource grid to produce LLRs. The channel estimation module 1425 may estimate channel parameters for all received signals, while the equalizer 1420 can equalize the received signals using the estimated channel parameters. The demapper 1430 may convert the equalized symbols into their corresponding soft bits.

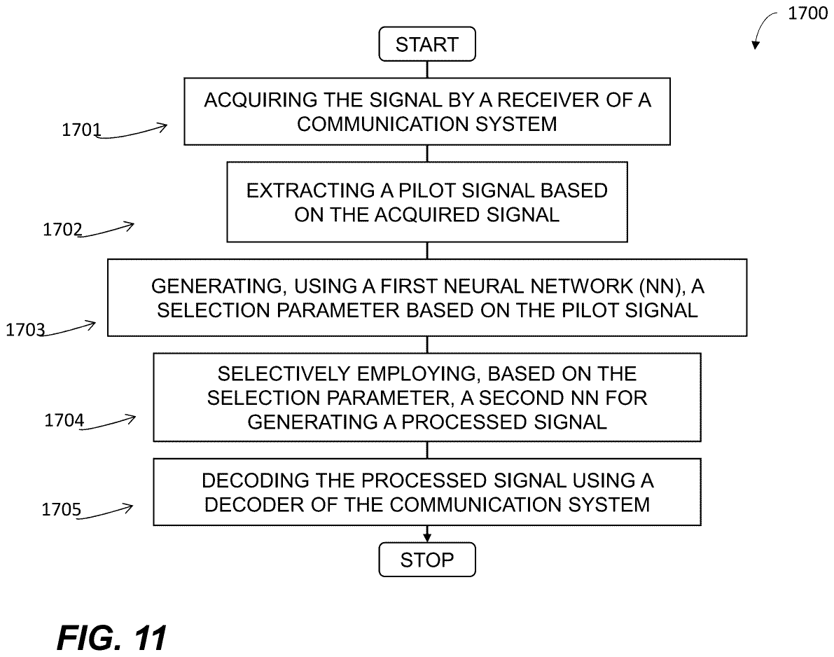

In at least some embodiments of the present technology, a processor 210 of an apparatus 310 or a processor 260 of an apparatus 320 of FIG. 3 is configured to execute a method 1700 illustrated in FIG. 11. Various steps of the method 1700 will now be described in greater details. The method 1700 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 1700 starts with acquiring, at operation 1701, the signal by a receiver of a communication system. For example, with reference to FIG. 3 and FIG. 11, the processor 260 of the apparatus 320 may initiate the method 1700 by acquiring a signal.

The method 1700 continues with extracting, at operation 1702, a pilot signal based on the acquired signal, the pilot signal being indicative of at least one channel condition parameter of a communication channel over which the signal has been acquired. For example, with reference to FIG. 3 and FIG. 8, the processor 260 of the apparatus 320 may employ a Fast Fourier Transform (FFT) module 1402 to extract pilot signals based on the acquired signal, as indicated by the numeral 1404.

The method 1700 continues with generating, at operation 1703, using a first Neural Network (NN), a selection parameter based on the pilot signal. For example, with reference to FIG. 3 and FIG. 8, the processor 260 of the apparatus 320 may employ the NN 1406 to generate a selection parameter based on the pilot signal.

The method 1700 continues with selectively employing, at operation 1704, based on the selection parameter, a second NN for generating a processed signal, the second NN having been trained to generate the processed signal based on the acquired signal, the processed signal being indicative of data symbols representing the acquired signal. For example, with reference to FIG. 3 and FIG. 8, the processor 260 of the apparatus 320 may selectively employ the neural receiver 1410 for generating the processed signal.

The method 1700 continues with decoding, at operation 1705, the processed signal using a decoder of the communication system. For example, with reference to FIG. 3 and FIG. 8, the processor 260 of the apparatus 320 may employ the decoder 1440 to decode the processed signal.

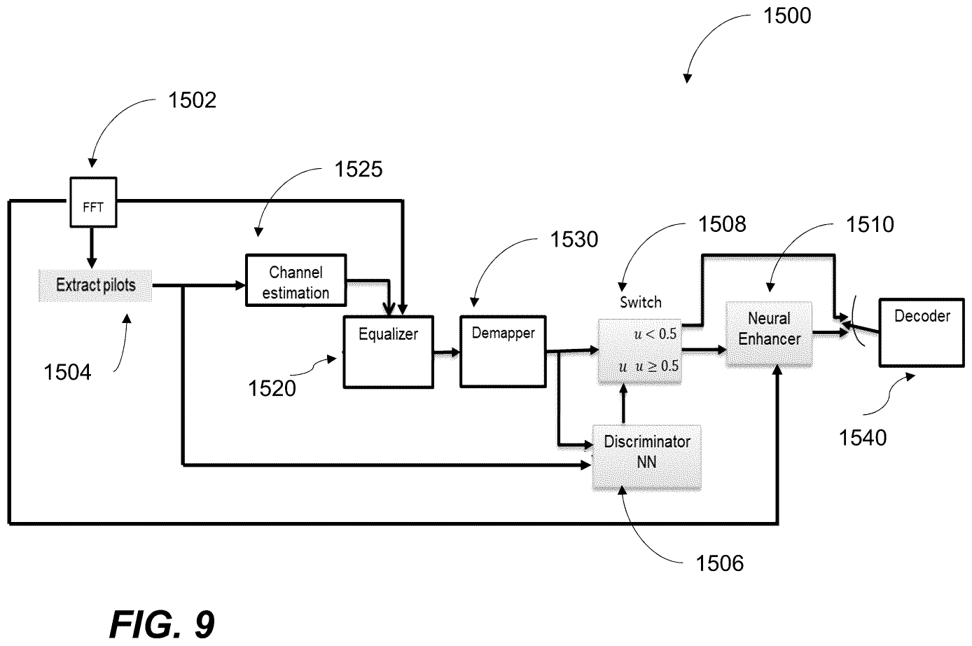

With reference to FIG. 9, there is depicted a processing pipeline 1500 of the hybrid receiver 1330 in accordance with a second embodiment of the present technology.

The received signals can first be processed by a deterministic receiver to compute Log-Likelihood Ratios (LLRs). The deterministic receiver may include an FFT module 1502, which converts the time-domain signals into the frequency domain, and an Extract pilots module 1504, which extracts the pilot signals from the received signals. The pilot signals and received signals can then be passed through a channel estimation module 1525, an equalizer 1520, and a demapper 1530 to compute the LLRs. The computed LLRs, concatenated with the input signals, can then be fed into a discriminator neural network (NN) 1506, which may determine whether these LLRs are adequate or if additional enhancement by a neural network is required.

The discriminator NN 1506 may output a value, denoted as u, which can range between 0 and 1. If the value of u is less than 0.5, the switch 1508 can forward the LLRs generated by the deterministic receiver directly to the decoder 1510 for further processing. Alternatively, if u≥0.5, the LLRs, along with the input signals, may be forwarded to the neural enhancer 1540. The neural enhancer 1540 can refine and improve the LLRs to provide enhanced soft bit representations, which are subsequently fed into the decoder 1510.

This architecture may provide flexibility by allowing initial deterministic processing to be selectively enhanced by neural network-based methods, depending on the discriminator's output. The neural enhancer 1540 and discriminator NN 1506 can be optimized to improve the resulting performance metrics, such as bit error rate (BER), while balancing computational complexity

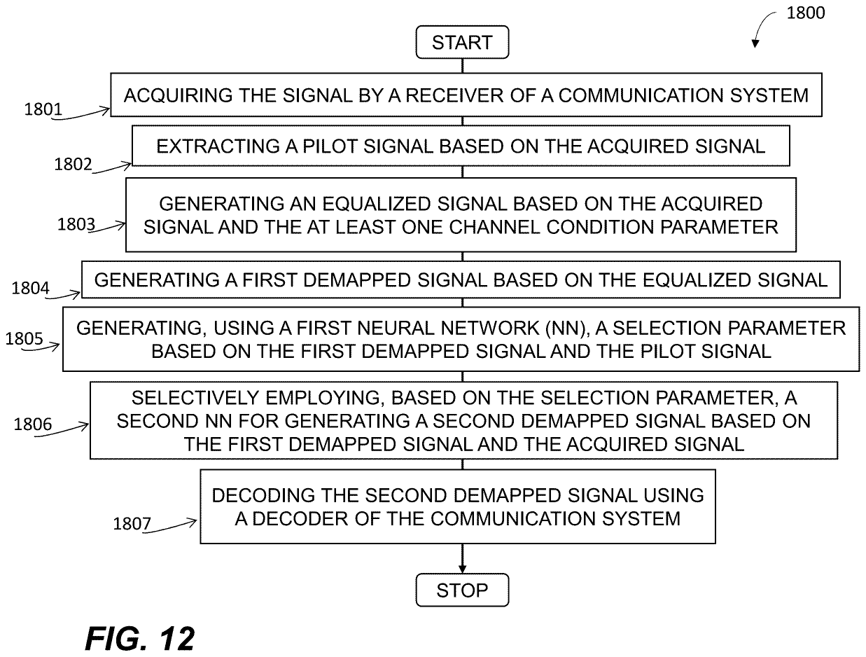

In at least some embodiments of the present technology, a processor 210 of an apparatus 310 or a processor 260 of an apparatus 320 of FIG. 3 is configured to execute a method 1800 illustrated in FIG. 12. Various steps of the method 1800 will now be described in greater details. The method 1800 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 1800 starts with acquiring, at operation 1801, the signal by a receiver of a communication system. For example, with reference to FIG. 3 and FIG. 12, the processor 260 of the apparatus 320 may initiate the method 1800 by acquiring a signal.

The method 1800 continues with extracting, at operation 1802, a pilot signal based on the acquired signal, the pilot signal being indicative of at least one channel condition parameter of a communication channel over which the signal has been acquired. For example, with reference to FIG. 3 and FIG. 9, the processor 260 of the apparatus 320 may employ a Fast Fourier Transform (FFT) module 1502 to extract pilot signals based on the acquired signal, as indicated by the numeral 1504.

The method 1800 continues with generating, at operation 1803, an equalized signal based on the acquired signal and the at least one channel condition parameter, the equalized signal being indicative of a modified acquired signal generated based on the at least one channel condition parameter. For example, with reference to FIG. 3 and FIG. 9, the processor 260 of the apparatus 320 may employ the equalizer 1520 to generate the equalized signal.

The method 1800 continues with generating, at operation 1804, a first demapped signal based on the equalized signal. For example, with reference to FIG. 3 and FIG. 9, the processor 260 of the apparatus 320 may employ the demapper 1530 to generate the first demapped signal.

The method 1800 continues with generating, at operation 1805, using a first Neural Network (NN), a selection parameter based on the first demapped signal and the pilot signal. For example, with reference to FIG. 3 and FIG. 9, the processor 260 of the apparatus 320 may employ the NN 1506 to generate the selection parameter.

The method 1800 continues with selectively employing, at operation 1806, based on the selection parameter, a second NN for generating a second demapped signal based on the first demapped signal and the acquired signal. For example, with reference to FIG. 3 and FIG. 9, the processor 260 of the apparatus 320 may employ the NN 1510 to generate the second demapped signal.

The method 1800 continues with decoding, at operation 1807, the second demapped signal using a decoder of the communication system. For example, with reference to FIG. 3 and FIG. 9, the processor 260 of the apparatus 320 may employ the decoder 1540 to decode the second demapped signal.

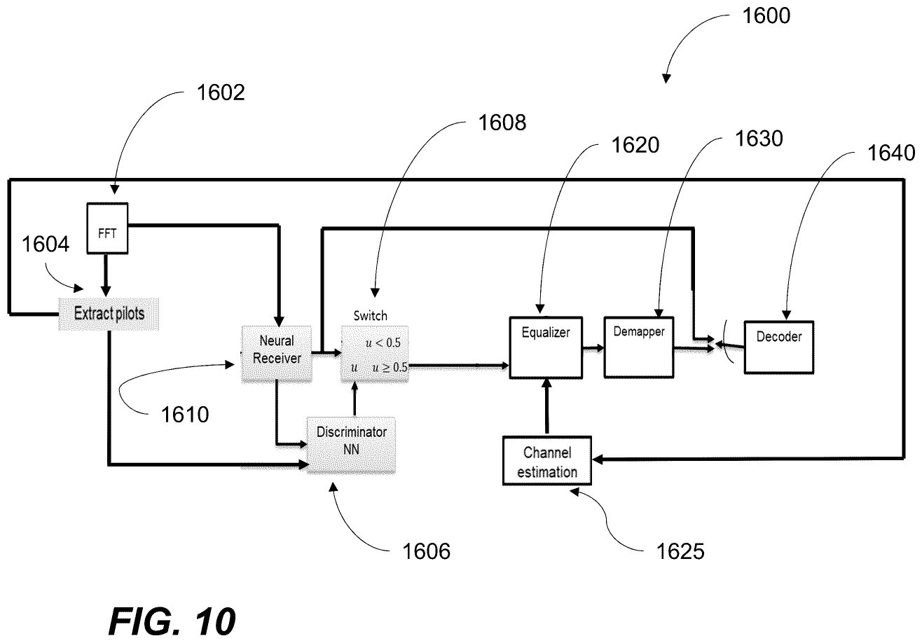

With reference to FIG. 10, there is depicted a processing pipeline 1600 of the hybrid receiver 1330 in accordance with a third embodiment of the present technology.

The received signals may first be processed in the frequency domain. The time-domain signals can be converted into frequency-domain signals using a Fast Fourier Transform (FFT) module 1602. The converted signals may then be forwarded to the Extract pilots module 1604, which can extract the pilot signals. These pilot signals may serve as inputs to the discriminator neural network (NN) 1606.

Initially, the received signals may be processed by the neural receiver 1610, which can generate Log-Likelihood Ratios (LLRs) based on the input signals. These LLRs, along with the extracted pilot signals, may then be analyzed by the discriminator NN 1606 to determine their adequacy. The discriminator NN 1606 may output a value, denoted as u, which can range between 0 and 1. If the discriminator NN determines that the LLRs are sufficiently accurate, it may produce a value u≥0.5, prompting the switch 1608 to pass the LLRs generated by the neural receiver 1610 directly to the decoder 1640 for further processing.

If the discriminator NN 1606 determines that the LLRs are not accurate enough, it may produce a value u<0.5, causing the switch 1608 to route the received signals (in their frequency-domain representation after FFT 1602) to the deterministic receiver. This path may include the channel estimation module 1625, which can estimate channel condition parameters, followed by the equalizer 1620, which may equalize the signals based on the channel estimates. The equalized signals may then be forwarded to the demapper 1630, which can demap the symbols into their corresponding LLRs. These LLRs may then be passed to the decoder 1640.

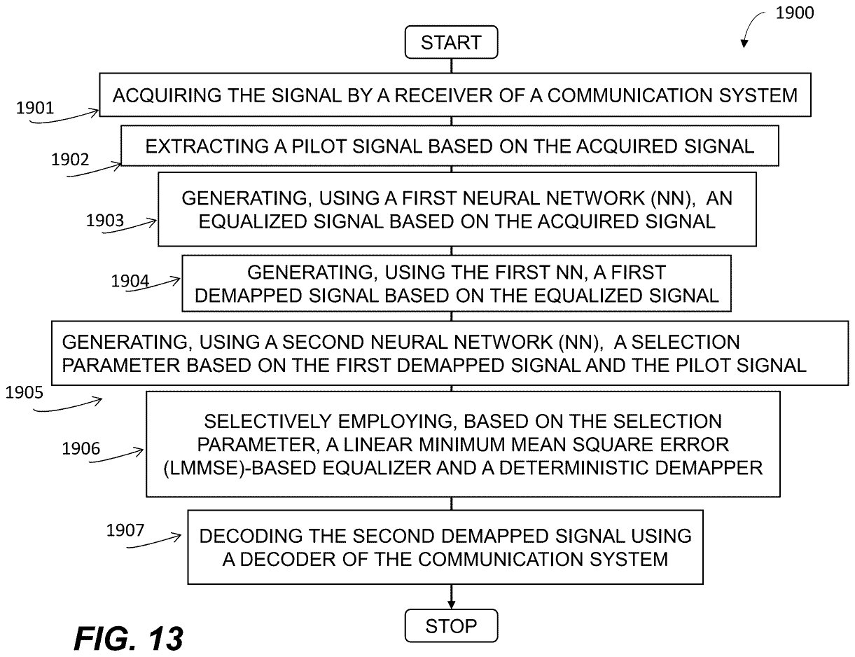

In at least some embodiments of the present technology, a processor 210 of an apparatus 310 or a processor 260 of an apparatus 320 of FIG. 3 is configured to execute a method 1900 illustrated in FIG. 13. Various steps of the method 1900 will now be described in greater details. The method 1900 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 1900 starts with acquiring, at operation 1901, the signal by a receiver of a communication system. For example, with reference to FIG. 3 and FIG. 13, the processor 260 of the apparatus 320 may initiate the method 1900 by acquiring a signal.

The method 1900 continues with extracting, at operation 1902, a pilot signal based on the acquired signal, the pilot signal being indicative of at least one channel condition parameter of a communication channel over which the signal has been acquired. For example, with reference to FIG. 3 and FIG. 10, the processor 260 of the apparatus 320 may employ a Fast Fourier Transform (FFT) module 1602 to extract pilot signals based on the acquired signal, as indicated by the numeral 1604.

The method 1900 continues with generating, at operation 1903, using a first Neural Network (NN), an equalized signal based on the acquired signal. For example, with reference to FIG. 3 and FIG. 10, the processor 260 of the apparatus 320 may employ the NN 1606 to generate the equalized signal.

The method 1900 continues with generating, at operation 1904, using the first NN, a first demapped signal based on the equalized signal. For example, with reference to FIG. 3 and FIG. 10, the processor 260 of the apparatus 320 may employ the NN 1606 to generate the first demapped signal.

The method 1900 continues with generating, at operation 1905, using a second Neural Network (NN), a selection parameter based on the first demapped signal and the pilot signal. For example, with reference to FIG. 3 and FIG. 10, the processor 260 of the apparatus 320 may employ the NN 1606 to generate the selection parameter.

The method 1900 continues with selectively employing, at operation 1906, based on the selection parameter, a Linear Minimum Mean Square Error (LMMSE)-based equalizer for generating a second equalized signal; and a deterministic demapper for generating a second demapped signal based on the second equalized signal. For example, with reference to FIG. 3 and FIG. 10, the processor 260 of the apparatus 320 may selectively employ the equalizer 1620 to generate the second equalized signal, and the demapper 1630 to generate the second demapped signal.

The method 1900 continues with decoding, at operation 1907, the second demapped signal using a decoder of the communication system. For example, with reference to FIG. 3 and FIG. 10, the processor 260 of the apparatus 320 may employ the decoder 1640 to decode the second demapped signal.

While the above-described implementations have been described and shown with reference to particular operations performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It will be appreciated that at least some of the operations of the methods 1700, 1800, and 1900 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for processing a signal, comprising:
acquiring the signal by a receiver of a communication system;
extracting a pilot signal based on the acquired signal, the pilot signal being indicative of at least one channel condition parameter of a communication channel over which the signal has been acquired;
generating, using a first neural network (NN), a selection parameter based on the pilot signal;
selectively employing, based on the selection parameter, a second NN for generating a processed signal, the second NN having been trained to generate the processed signal based on the acquired signal, the processed signal being indicative of data symbols representing the acquired signal; and
decoding the processed signal using a decoder of the communication system.

2. The method of claim 1, further comprising:
selectively employing, based on the selection parameter, an NN-based equalizer and an NN-based demapper for generating the processed signal, wherein the selectively employing the NN-based equalizer and the NN-based demapper comprises:
generating an equalized signal from the acquired signal using the NN-based equalizer; and
generating a demapped signal from the equalized signal using the NN-based demapper.

3. The method of claim 1, wherein the selectively employing comprises comparing the selection parameter against a predetermined threshold.

4. The method of claim 1, wherein the acquired signal is a time-domain signal, the extracting the pilot signal based on the time-domain signal comprises:
generating a frequency-domain representation of the time-domain signal; and
extracting the pilot signal from the frequency-domain representation.

5. The method of claim 1, wherein the first NN is trained using a data set including:
pilot training signals,
corresponding labels associated with the pilot training signals,
a first processed training signal, generated by the second NN, based on the pilot training signals, and
a second processed training signal, generated by a Linear Minimum Mean Square Error (LMMSE)-based equalizer and a deterministic demapper, based on the pilot training signals;
wherein the first NN is configured to output a parameter indicative of whether the first processed training signal has a better performance than the second processed training signal, according to a performance metric.

6. The method of claim 5, wherein the performance metric is a bit error rate parameter.

7. The method of claim 1, wherein the acquired signal is an orthogonal frequency division multiplexing (OFDM) signal.

8. The method of claim 1, wherein the at least one channel condition parameter includes a signal-to-noise ratio (SNR), a channel gain, a phase shift, a noise variance, a delay spread, and a Doppler shift.

9. A method for processing a signal, comprising:
acquiring the signal by a receiver of a communication system;
extracting a pilot signal based on the acquired signal, the pilot signal being indicative of at least one channel condition parameter of a communication channel over which the signal has been acquired;
generating an equalized signal based on the acquired signal and the at least one channel condition parameter, the equalized signal being indicative of a modified acquired signal generated based on the at least one channel condition parameter;
generating a first demapped signal based on the equalized signal;
generating, using a first Neural Network (NN), a selection parameter based on the first demapped signal and the pilot signal;
selectively employing, based on the selection parameter, a second NN for generating a second demapped signal based on the first demapped signal and the acquired signal; and
decoding the second demapped signal using a decoder of the communication system.

10. The method of claim 9, wherein
the first demapped signal is indicative of a first set of log-likelihood ratios (LLRs), the first set of LLRs representing a first likelihood of data symbols representing the acquired signal; and
the second demapped signal is indicative of a second set of log-likelihood ratios (LLRs), the second set of LLRs representing a second likelihood of data symbols representing the acquired signal.

11. The method of claim 9, wherein the selectively employing comprises comparing the selection parameter against a predetermined threshold.

12. The method of claim 9, wherein the acquired signal is a time-domain signal, the generating the equalized signal based on the time-domain signal comprises:
generating a frequency-domain representation of the time-domain signal; and
generating the equalized signal based on the frequency-domain representation.

13. The method of claim 12, wherein the generating the equalized signal comprises:
generating the equalized signal based on the frequency domain representation and the at least one channel condition parameter.

14. The method of claim 9, wherein the first NN is trained using a data set including:
pilot training signals,
corresponding labels associated with the pilot training signals,
a first demapped training signal, generated by a Linear Minimum Mean Square Error (LMMSE)-based equalizer and a deterministic demapper, based on the pilot training signals; and
a second demapped training signal, generated by the second NN, based on the pilot training signals;
wherein the first NN is configured to output a parameter indicative of whether the second demapped training signal has a better performance than the first demapped training signal, according to a performance metric.

15. The method of claim 14, wherein the performance metric is a bit error rate parameter.

16. A method for processing a signal, comprising:
acquiring the signal by a receiver of a communication system;
extracting a pilot signal based on the acquired signal, the pilot signal being indicative of at least one channel condition parameter of a communication channel over which the signal has been acquired;
generating, using a first Neural Network (NN), an equalized signal based on the acquired signal;
generating, using the first NN, a first demapped signal based on the equalized signal;
generating, using a second Neural Network (NN), a selection parameter based on the first demapped signal and the pilot signal;
selectively employing, based on the selection parameter,
a Linear Minimum Mean Square Error (LMMSE)-based equalizer for generating a second equalized signal; and
a deterministic demapper for generating a second demapped signal based on the second equalized signal; and
decoding the second demapped signal using a decoder of the communication system.

17. The method of claim 16, wherein the equalized signal is indicative of a modified acquired signal generated based on the at least one channel condition parameter.

18. The method of claim 16, wherein
the first demapped signal is indicative of a first set of log-likelihood ratios (LLRs), the first set of LLRs representing a first likelihood of data symbols representing the acquired signal; and
the second demapped signal is indicative of a second set of log-likelihood ratios (LLRs), the second set of LLRs representing a second likelihood of data symbols representing the acquired signal.

19. The method of claim 16, wherein the second NN is trained using a data set including:
pilot training signals,
corresponding labels associated with the pilot training signals,
a first demapped training signal, generated by the first NN, based on the pilot training signals; and
a second demapped training signal, generated by a Linear Minimum Mean Square Error (LMMSE)-based equalizer and a deterministic demapper, based on the pilot training signals;
wherein the second NN is configured to output a parameter indicative of whether the first demapped training signal has a better performance than the second demapped training signal, according to a performance metric.

20. The method of claim 16, wherein the selectively employing comprises comparing the selection parameter against a predetermined threshold.

21. The method of claim 18, wherein the performance metric is a bit error rate parameter.
